(19) United States
(12) Patent Application Publication
(10) Pub. No.: US 2023/0015535 A1
(43) Pub. Date: Jan. 19, 2023

(54) DIGITAL PROJECT BASED COMPETITIVE BIDDING IN GOVERNMENT CONTRACTS

(71) Applicant: Chad Smeltzer, Aurora, IL (US)

(72) Inventor: Chad Smeltzer, Aurora, IL (US)

(21) Appl. No.: 17/377,570

(22) Filed: Jul. 16, 2021

(51) Int. Cl. G06Q 30/08; G06Q 50/26; G06Q 20/10; G06T 17/00

(52) U.S. Cl. CPC G06Q 30/08; G06Q 50/26; G06Q 20/102; G06T 17/00; G06T 2200/08; G06T 2200/04

(57) ABSTRACT

A substantially fully-digital procurement process for government contracts that expeditiously fulfills a government entity's procurement needs within a geographical location in a fair and competitive manner. Online digital projects created using audio and video technologies allow potential bidders to easily visualize the tasks and competitively bid for them. Audio and visual features may be added to all stages—communication among stakeholders, planning of a digital project, preparation of a digital solicitation, and bidding on the solicitation—of the competitive bidding process. Substantially all project specification documents may be replaced using visual and audio technologies, and blockchain-based smart contracts to enable the government entity to digitally execute a procurement solicitation. Potential suppliers and contractors are connected on a geospatial location mapping system to expedite the procurement and add accessibility to local businesses, connect minority businesses, and create local economic sustainability. User rating makes the bidding process more transparent, fair, and competitive.

### TECHNICAL FIELD

This disclosure relates generally to competitive bidding, and more specifically to an online platform that facilitates a digital project based electronic competitive bidding to implement a substantially fully-digital procurement process for government contracts that expeditiously fulfills a government entity's procurement needs within a geographical location in a fair and competitive manner.

### BACKGROUND

Government entities use taxpayer dollars to purchase trillions of dollars of goods and services annually. In order to keep the government from giving tax dollars to only one company and to stimulate economic opportunities for everyone and allow for fair competition for those tax dollars, the federal government created the Federal Acquisition Regulations (FAR) in 1984 requiring a competitive bidding process in federal contract. The FAR rules are based on a policy to prevent collusion and corruption in government contracts, and stop mismanagement of taxpayer funds.

Each government entity determines the type of competitive bidding method they will use to meet their FAR competitive bidding process requirements to purchase the goods and services. The methods require a competitive bidding process. The overall goal is to get as many contractors and suppliers as possible to respond to the government solicitations and award the contract to the most responsible and qualified lowest bidder.

Government entities typically advertise their procurement solicitations using one or more methods including, but not limited to, fax transmissions, phone conversations, emails, postal mails, newspaper ads, classified ads, software, paper deliveries, web site displays on their own or third party websites. In some cases, the government entities may post ads and/or flyers on the doors of city halls or other government buildings. This is currently considered as a fair, open, transparent, and competitive bidding procurement process that most government entities use to buy goods and services. The advertised procurement may contain basic information about the advertised solicitation that includes, but not limited to, project information, project titles, project scope, documents, and bid opening dates. The solicitation then gets reviewed by contractors and suppliers. In some cases, the government entities may allow contractors and suppliers to see who their competition is by using a plan holders list. The plan holder list gives information about one contractor or supplier to other contractors and suppliers because the list includes names, email addresses, and business addresses of different contractors/suppliers. This list allows contractors and suppliers to work together in responding to the advertised solicitation. However, the plan holders list, which is published to everyone, may easily allow contractors to collude. Therefore, to avoid such collusion, some government entities recently have started not allowing the plan holders list to be made available to everyone. Furthermore, such a list may no longer be needed anyway because various search engines on the Internet have changed the way one can search for businesses using search engine optimization.

It is observed that the contractors, suppliers, and an estimated 60% of government entities still use the postal system to send and respond to procurement advertisements. An estimated 40% have transitioned to an electronic procurement type software to exchange advertised solicitation information. Using the postal mail system to send documents back and forth between entities is costly and time consuming. Printing of solicitation documents by contractors, suppliers, and government entities has very costly implications to the environment and taxpayer funds. Bid solicitation documents can range from 50 to 1,000 pages (or more in special cases). These documents get printed by contractors and suppliers in order to fill out the required fields to respond to the bid solicitation via postal mail. In some cases, the filled-out documents may be scanned and sent electronically via email or through the Internet. The printing, mailing, and review of documents related to request for proposal (RFP), bid information, bid qualifications, and quotes is an incredibly challenging process that costs billions in taxpayer funds and wastes millions of human hours in trying to find, respond, advertise, and plan procurement solicitations.

The current antiquated methods of the procurement process have led to numerous scandals, corruption, collusion, lawsuits, prison time, wasted taxpayer funds, detrimental environmental impact, and poor workmanship of unqualified contractors and suppliers.

Businesses that sell goods and services to government entities take advantage of the current procurement process because it typically awards the contract to the lowest bidder of government solicitation based on outdated laws and policies. Various government entities do not have enough time to properly vet contractors and suppliers, resulting in planned obsolescence, changed orders, increased project delays, and reduced useful life cycles.

Currently, most of the technology available to connect buyers and sellers uses the 1983 National Institute of Governmental Purchasing Commodity/Services (NIGPC) code system. However, the code system does not work for businesses that may change their business types such as, for example, their products, services, and materials they use annually. Thus, the code system has limited use when trying to connect buyers and sellers. Furthermore, the code system is a part of the federal taxonomy system in which technology is used to match a business based on its commodity codes to help find bid solicitations. The reliance on this code-based technology leaves businesses unable to find accurate bid solicitation information because there is no standardized way of using the national code system to match bids to businesses.

### SUMMARY

This Summary provides a simplified form of concepts that are further described below in the Detailed Description. This Summary is not intended to identify key or essential features and should therefore not be used for determining or limiting the scope of the claimed subject matter.

As mentioned before, the current approach for bidding on government contracts is antiquated, cumbersome, wasteful, error-prone, inefficient, and environmentally unfriendly. For example, there is still a heavy reliance on printing and mailing of a large number of documents, resulting in a significant (and, absolutely unnecessary) delay in fulfilling a solicitation. Furthermore, currently-available procurement software technology does not allow for government entities to know what businesses are within their own communities that could easily meet their procurement requirements. Without a better searching method, government employees are often left without resources to find business information of contractors and suppliers who can meet their solicitations. In some cases, this leaves only one bidder to respond to government solicitations, whereas other contractors and suppliers miss the opportunity to find and win the advertised solicitation. Additionally, current procurement software technology does not provide an all-in-one software or multiple software applications connected through Application Programming Interfaces (APIs) that simplify and streamline the procurement process to help public and private entities to execute a digital, transparent, open, fair, and competitive bidding process. Google® and other search engines are valuable, but do not provide detailed information about all the services, materials, products that government entities are looking for. Thus, the employees of potential contractors/suppliers have to rely on tradeshows, education seminars, sales presentations, engineers, consultants and others to provide information about what types of products, materials, and services are available to fulfill the government solicitation.

It is therefore desirable to devise a substantially fully-digital procurement process for government contracts that expeditiously fulfills a government entity's procurement needs within a geographical location in a fair and competitive manner. It is further desirable to streamline the request for information, proposals, qualification, quoting, estimating, bidding, and buying opportunities of public and private sector entities when procuring goods and services from qualified manufacturers, distributors, suppliers, and/or contractors to maintain the integrity and fairness of the competitive procurement process using taxpayer and e-commerce funds.

As a solution, particular embodiments of the present disclosure relate to a system and method that emphasizes and facilitates the use of digital camera images, videos, drone video/images, Light Detection and Ranging (LIDAR) technology, virtual reality, augmented reality, augmented mixed reality, other three dimensional (3D) camera technology, audio files, and/or Geographical Information System (GIS) data (or geographical asset management software) by government entities to create digital projects allowing for contractors and suppliers to easily see/visualize the projects (or tasks or work requests) and competitively bid for those projects or requests. Due to substantial avoidance of reliance on printing, mailing, and review of physical documents, the present approach significantly reduces the amount of time currently needed to plan, prepare, and create a request for information, qualifications, proposals, quotes, estimates, and to competitively bid for a contract and/or agreement of any kind for purchase of services or goods. For example, using the methodology of the present disclosure, buyers (for example, government entities) and sellers (for example, contractors or suppliers) may post competitive bids quickly and get projects or purchases awarded in minutes, hours, and days versus months (as is typical currently). In particular embodiments, substantially all project specification documents may be replaced using visual and audio technologies, as well as smart documents (on a blockchain) to enable a government entity to digitally execute a formal, informal, or micro purchasing procurement process.

In certain embodiments, an online platform may facilitate the digital project based electronic competitive bidding to implement a substantially fully-digital procurement process. The platform may be divided into two sides keeping businesses responding to procurement opportunities separate from the government entities generating the digital solicitations during the informal or formal competitive bidding process. In particular embodiments, the online platform may allow: (i) relevant entities to plan together sharing communication and information about the solicitation; (ii) sending of digital quotes; (iii) bidding on procurement processes; (iv) sending of notifications to sellers looking for the buyers' solicitations using geospatial locations; (v) posting of various project images, documents, and videos; (vi) connecting various entities together in a digital chat or planning room for consortium bulk purchasing; and the like. The government entities can work together as one unit to consolidate their budgets and solicitations improving the creation of one or multiple solicitations and can then post the solicitation(s) on the online platform to improve their chances of attracting more contractors or suppliers and driving down their cost. The online platform also may allow the contractors and suppliers to find solicitations on a Global Positioning System (GPS) based display, as geospatial lateral and longitude coordinates on a mapping system, or through a geographical asset management system.

In particular embodiments, blockchain processes may be embedded into the entire procurement process—from generation of digital solicitation by a government entity to submission of a winning digital bid by a qualified bidder and eventual payment to the winning bidder. Smart contracts, digital currencies (in e-commerce), cryptocurrencies, non-fungible tokens (NFTs), and other secure online mechanisms (of contract validation and payment) may be used to protect images or assets of the buyers (for example, government entities) or other persons posting a bid solicitation.

Furthermore, a user rating system may be implemented to significantly improve the public and private sector's ability to find information about a business type to meet their procurement needs within a geographical location. The rating of various users (for example, suppliers or contractors) by the buyers (for example, government entities) may: (i) make the competitive bidding process more transparent, fair, competitive; (ii) establish integrity of the process; (iii) reduce collusion and corruption; (iv) increase accountability; and (v) reduce environmental pollution. The user rating system may give the public and private sector the ability to not always choose the lowest bidder for a purchase.

In one embodiment, the present disclosure is directed to a method, which comprises: (i) receiving, by a computing system, a digital solicitation from a government entity for a public works project being offered by the government entity for competitive bidding, wherein the digital solicitation includes: (a) an electronic contract document containing procurement terms and conditions of the government entity for the public works project, and (b) a digital project comprising data that enable electronic visualization of a geographical location, physical attributes, and critical ancillary details of the public works project to facilitate an expeditious bidding without a need for a visit to a physical location of the public works project and a review of textual details of the public works project; (ii) electronically providing, by the computing system, the digital solicitation to a plurality of bidders; (iii) hosting, by the computing system, an online question-and-answer session of a pre-defined duration between the government entity and the plurality of bidders to enable one or more bidders in the plurality of bidders to discuss the digital solicitation with the government entity prior to conclusion of time period for competitive bidding; (iv) receiving, by the computing system, a bidder-specific digital bid for the digital solicitation from one or more bidders in the plurality of bidders; (v) electronically providing, by the computing system, all received digital bids to the government entity for review; (vi) receiving, by the computing system, a result of the competitive bidding from the government entity identifying a winning digital bid and a corresponding winning bidder from the plurality of bidders; and (vii) electronically providing, by the computing system, the result of the competitive bidding to each bidder in the plurality of bidders.

In particular embodiments, a “digital project” as per teachings of the present disclosure may comprise two or more of the following: (i) an annotated digital image of the public works project; (ii) a digital twin generated from pictures associated with the public works project; (iii) a three-dimensional (3D) digital model of the public works project; (iv) a digital video related to the public works project; (v) a digital audio recording related to the public works project; (vi) a Geographical Information System (GIS) location data for the public works project; (vii) a drone footage of the public works project; (viii) a geospatial location information for the public works project; (ix) a link to a digital media file containing data about the public works project; (x) a plurality of standardized construction codes relevant to the public works project and embedded with visual aids identifying the public works project; and (xi) electronic documents providing constructional details of the public works project.

In another embodiment, the present disclosure is directed to a computer program product comprising a non-transitory computer-usable medium having computer-readable program code embodied therein, wherein the computer-readable program code, when executed by a computing system, causes the computing system to implement a method. The method comprises: (i) receiving a digital solicitation from a government entity for a public works project being offered by the government entity for competitive bidding, wherein the digital solicitation includes: (a) an electronic contract document containing procurement terms and conditions of the government entity for the public works project, and (b) a digital project comprising data that enable electronic visualization of a geographical location, physical attributes, and critical ancillary details of the public works project to facilitate an expeditious bidding without a need for a visit to a physical location of the public works project and a review of textual details of the public works project; (ii) electronically providing the digital solicitation to a plurality of bidders; (iii) hosting an online question-and-answer session of a pre-defined duration between the government entity and the plurality of bidders to enable one or more bidders in the plurality of bidders to discuss the digital solicitation with the government entity prior to conclusion of time period for competitive bidding, wherein the pre-defined duration for the online question-and-answer session is established by the government entity and terminates prior to the conclusion of the time period for competitive bidding; (iv) receiving a bidder-specific digital bid for the digital solicitation from one or more bidders in the plurality of bidders; (v) electronically providing all received digital bids to the government entity for review; (vi) receiving a result of the competitive bidding from the government entity identifying a winning digital bid and a corresponding winning bidder from the plurality of bidders; and (vii) electronically providing the result of the competitive bidding to each bidder in the plurality of bidders.

In a further embodiment, the present disclosure is directed to a computing system that comprises: a memory storing program instructions; and a processing unit coupled to the memory and operable to execute the program instructions. In the computing system, the program instructions, when executed by the processing unit, cause the computing system to: (i) receive a digital solicitation from a government entity for a public works project being offered by the government entity for competitive bidding, wherein the digital solicitation includes: (a) an electronic contract document containing procurement terms and conditions of the government entity for the public works project, and (b) a digital project comprising data that enable electronic visualization of a geographical location, physical attributes, and critical ancillary details of the public works project to facilitate an expeditious bidding without a need for a visit to a physical location of the public works project and a review of textual details of the public works project; (ii) provide the digital solicitation to a plurality of bidders; (iii) host an online question-and-answer session of a pre-defined duration between the government entity and the plurality of bidders to enable one or more bidders in the plurality of bidders to discuss the digital solicitation with the government entity prior to conclusion of time period for competitive bidding; (iv) receive a bidder-specific digital bid for the digital solicitation from one or more bidders in the plurality of bidders; (v) provide all received digital bids to the government entity for review; (vi) receive a result of the competitive bidding from the government entity identifying a winning digital bid and a corresponding winning bidder from the plurality of bidders; and (vii) provide the result of the competitive bidding to each bidder in the plurality of bidders.

Thus, the competitive bidding as per teachings of the present disclosure may be facilitated by adding advanced media technology (such as audio and visual features) to all stages—communication among stakeholders, planning of a digital project, preparation of a digital solicitation, and bidding on the solicitation—of the competitive procurement process. Furthermore, connecting all suppliers and contractors on a geospatial location mapping system may not only expedite the procurement process, but also may add accessibility to local businesses, connect minority businesses, and create local economic sustainability. The online platform-based implementation of a competitive bidding process may save all users of the online platform time and money, increase efficiencies, and provide a more transparent and competitive bidding environment. The use of digital communication features by one or more entities (for example, government entities) to coordinate and plan a procurement process may benefit the buying power of the entities and also may improve the performance of contractors and suppliers.

### BRIEF DESCRIPTION OF THE DRAWINGS

A more complete understanding of the present disclosure may be obtained by reference to the following Detailed Description when taken in conjunction with the accompanying Drawings. For ease of discussion, the same reference numbers in different figures indicate similar or identical items.

FIG. 1 is an exemplary arrangement to implement a digital project-based competitive bidding as per particular embodiments of the present disclosure.

FIG. 2 shows an exemplary flowchart depicting various steps that may be performed by a computing system as per particular embodiments of the present disclosure to facilitate digital project based competitive bidding as per teachings of the present disclosure.

FIG. 3 is an exemplary illustration of how digital projects may improve a competitive bidding-based procurement process.

FIG. 4 depicts an exemplary flow of tasks associated with a government entity and a bidder to implement the competitive bidding methodology as per particular embodiments of the present disclosure.

FIGS. 5A-5D illustrate exemplary screenshots that may be generated during implementation of the digital project-based competitive bidding as per particular embodiments of the present disclosure.

FIG. 6 depicts an exemplary arrangement to implement the digital project-based competitive bidding in a secure, de-centralized network as per particular embodiments of the present disclosure.

FIG. 7 illustrates an example configuration of a computer system that can be used to implement the competitive bidding methodology described herein.

### DETAILED DESCRIPTION

In the following detailed description, numerous specific details are set forth in order to provide a thorough understanding of the disclosure. However, it will be understood by those skilled in the art that the present disclosure may be practiced without these specific details. In other instances, well-known methods, procedures, components and circuits have not been described in detail so as not to obscure the teachings of the present disclosure. Furthermore, this disclosure provides various example implementations or embodiments, as described and as illustrated in the drawings. However, this disclosure is not limited to the implementations described and illustrated herein, but can extend to other implementations, as would be known or as would become known to those skilled in the art.

Reference throughout this specification to “one embodiment,” “particular embodiments,” “this implementation,” “some embodiments,” or other terms of similar import, means that a particular feature, structure, or characteristic described in connection with the embodiment is included in at least one embodiment or implementation of the present disclosure. Thus, the appearances of these phrases in various places throughout this specification are not necessarily all referring to the same implementation/embodiment. Furthermore, the particular features, structures, or characteristics may be combined in any suitable manner in one or more embodiments. Also, depending on the context of discussion herein, a singular term may include its plural forms and a plural term may include its singular form. Similarly, a hyphenated term (e.g., “digital project-based,” “bidder-specific”, “three-dimensional,” etc.) may be occasionally interchangeably used with its non-hyphenated version (e.g., “digital project based,” “bidder specific”, “three dimensional,” etc.), and a capitalized entry (e.g., “Government System,” “Bidder System,” “Global Positioning System,” etc.) may be interchangeably used with its non-capitalized version (e.g., “government system,” “bidder system,” “global positioning system,” etc.). Such occasional interchangeable uses shall not be considered inconsistent with each other.

It is noted at the outset that the terms “coupled,” “operatively coupled,” “connected”, “connecting,” “electrically connected,” etc., are used interchangeably herein to generally refer to the condition of being electrically/electronically connected in an operative manner. Similarly, a first entity is considered to be in “communication” with a second entity (or entities) when the first entity electrically sends and/or receives (whether through wireline and/or wireless means) information signals (whether containing address, data, or control information) to/from the second entity regardless of the type (analog or digital) of those signals. It is further noted that various figures shown and discussed herein are for illustrative purpose only, and are not drawn to scale.

The terms “first,” “second,” etc., as used herein, are used as labels for nouns that they precede, and do not imply any type of ordering (e.g., spatial, temporal, logical, etc.) unless explicitly defined as such. Furthermore, items or features appearing in different figures may be identified using the same reference numeral for ease of discussion. However, such identification does not imply that the commonly-referenced items/features are identical across all embodiments.

It is noted here that, for ease of discussion, a computer software, program code or module may be referred to as “performing,” “accomplishing,” or “carrying out” a function or process. However, it is evident to one skilled in the art that such performance may be technically accomplished by a processor when the software or program code is executed by the processor. The program execution would cause the processor to perform the tasks or steps instructed by the software to accomplish the desired functionality or result. However, for the sake of convenience, in the discussion below, a processor or software component may be referred to interchangeably as an “actor” performing the task or action described, without technically dissecting the underlying software execution mechanism.

In the discussion herein, the terms “third party system”, “host system”, and “bid management system” may be used interchangeably merely for ease of description. Furthermore, it is noted that, in the discussion below, the government public works projects are merely used as an example of the projects suitable for the digital competitive bidding as per teachings of the present disclosure. Thus, although the discussion is primarily focused on competitive bidding in government contracts for ease of description and for the sake of brevity, the teachings of the present disclosure remain equally applicable to competitive bidding in many other areas—whether in a business-to-business (B2B) setting (such as, for example, a motel owner seeking competitive bids for motel renovation), or a non-B2B setting (such as, for example, a homeowner looking to invite competitive bids from contractors for a home repair project), and also whether the bid is solicited for a construction project or a non-construction project (e.g., a vacation home rental, to operate a daycare center, and the like).

It is noted here that, in the discussion below, a government entity (or any other party inviting bids) may be considered a “buyer”, whereas an entity submitting a competitive bid may be interchangeably referred to as a “seller,” “supplier,” “contractor,” or “bidder”, depending on the context of discussion. In the present disclosure, the term “government entity” may refer to any government or quasi-government agency such as, for example, a state or federal government agency, a county re-development authority, a community outreach agency, a city public works department, and so on. On the other hand, a “bidder” may be a contractor, a real estate developer, a builder, a structural engineering consultant, a builder's group or consortium, a roofing company, an excavating service provider, a public works company/agent, a building inspection service, and the like. Generally, a supplier, a seller, a buyer, a contractor, a bidder, a government entity, or a third party bid manager each may be a human operator or a non-human entity (such as a for-profit corporation, a non-profit enterprise, a government agency, or any other commercial or non-commercial entity). In particular embodiments, the third party bid manager may be an independent entity not connected/related with either the supplier or the buyer, except for its provision of the services for creation and fulfillment of digital solicitations (through competitive bidding) as per the teachings of the present disclosure.

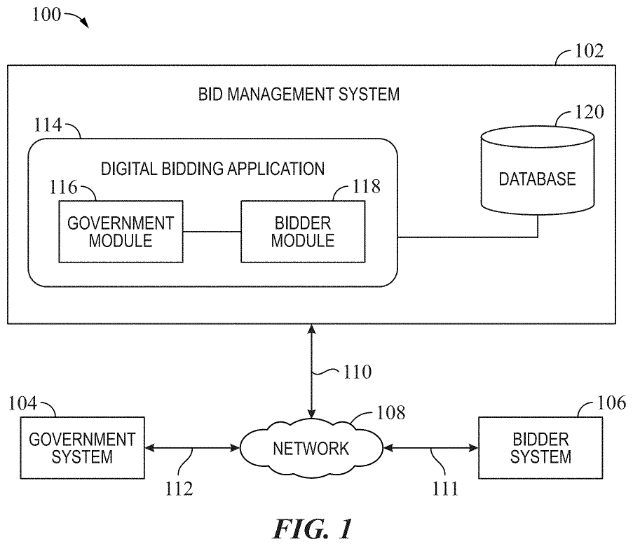

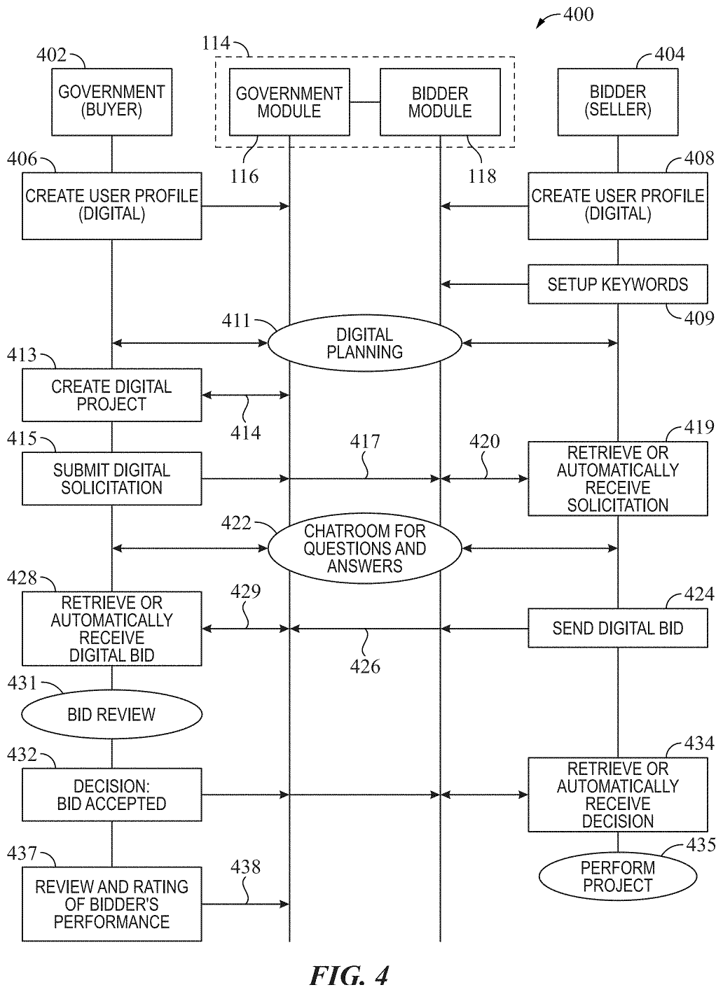

FIG. 1 is an exemplary arrangement 100 to implement a digital project-based competitive bidding as per particular embodiments of the present disclosure. In the arrangement 100 of FIG. 1, a bid management system (BMS) (also interchangeably referred to as a host system or a third-party system) 102 is shown to be in communication with a government (or buyer) system 104 and a bidder (or seller) system 106 via a communication network 108. In the embodiment of FIG. 1, each system 102, 104, 106 may communicate with any of the other system(s), as shown by the exemplary bi-directional arrows 110-112. In a typical implementation, the communication network 108 may be an Internet Protocol (IP) network, such as the Internet. However, in other embodiments, the third party system 102 may individually communicate with the government system 104 and the bidder system 106 via different types of communication network(s) that support bi-directional communication. For example, the host system 102 may be connected to the government system 104 via a corporate intranet or a specific communication platform made available to the government entity, whereas the bidder system 106 may communicate with the host system 102 via the Internet. It is noted that the bi-directional arrows 110-112 are exemplary in nature; they do not imply that all types of communication between two entities connected by an arrow is bi-directional. FIG. 4 (discussed later) illustrates some examples of unidirectional communication.

In the embodiment of FIG. 1, the buyer system 104 may be associated with a government entity. However, as mentioned earlier, in other embodiments, the buyer system 104 may be associated with a non-government entity such as a homeowner, a private business owner (for example, a restaurant owner, or a motel operator), and the like. The seller system 106, on the other hand, may be associated with a potential bidder taking part in a competitive bidding on a digital solicitation offered by the government entity as per teachings of the present disclosure. It is understood that there may be more than one bidder taking part in the competitive bidding. However, for ease of illustration and simplicity of discussion, only one bidder system 106 is shown in FIG. 1 instead of multiple bidder systems connected to the network 108. The discussion below in the context of the single bidder system 106 remains equally applicable to all other bidders and their systems (not shown) associated with the competitive bidding.

The BMS system 102 may be associated with a third party that merely provides an online platform (through the BMS system 102) to perform an independent, third party-based management of digital solicitations by government entities and corresponding bids from the suppliers/contractors, and also to facilitate online communication between a government entity (through the government system 104) and one or more potential bidders (through a respective bidder system, such as the system 106), as discussed in more detail later below. In other words, as noted before, in particular embodiments, the third party bid manager may be an independent entity that is neither affiliated nor associated with either the government entity or the bidders, except to the extent of providing its bid management service—which includes creation and fulfillment of a government entity's digital solicitations (through competitive bidding) as per the teachings of the present disclosure—through an online platform that also “links” the government entity to potential bidders. Thus, generally, the third party bid manager may simply provide its services to a buyer and a supplier using its BMS system 102, and offer the online platform (through the BMS system 102) as a “link” that connects the supplier to the buyer to enable them to communicate with each other to successfully conclude a transaction. In particular embodiments, the third party bid manager may charge a fee for its services.

The third party (or BMS) system 102 may include a digital bidding application 114 (or, simply, a “bidding application”), which may be a software module that performs the desired bid management as per teachings of the present disclosure. In one embodiment, the bidding application 114 may contain two software modules—a government module 116 and a bidder module 118—to enable the bidding application 114 to assist a government entity in creating and fulfilling its digital solicitation, to facilitate interactions between the government entity and potential bidders, and also to allow qualified bidders to submit their bids. As shown in FIG. 1, the software modules 116, 118 may be communicatively coupled with each other for exchange of data and other content therebetween to provide a seamless user experience to the users of the systems 104, 106. In particular embodiments, the bidding application 114 may be communicatively coupled to a database 120 in the third party's system 102. Various solicitation-specific files (audio, video, text, or other files), data (for example, GPS or GIS content, Building Information Modeling (BIM) data, standard construction codes, and the like), bidding information (for example, bid quotes or documents received from the bidders), Application Programming Interfaces (APIs) to external programs or applications (for example, a program that may be used to generate a digital twin of a physical object, a reality capture application, a Virtual Reality (VR) or Augmented Reality (AR) generator utility, and the like), and other relevant information necessary to implement the digital project-based competitive bidding as per teachings of the present disclosure may be stored in the database 120. In certain embodiments, user profiles (discussed later) created by the users of the systems 104, 106, and communication (such as chats, discussions, question-and-answer threads) among various users of the system 102 also may be stored in the database 120. It is noted that, in some embodiments, the database 120 may be an integral part of the third party system 102 as shown, for example, in the embodiment of FIG. 1. In other embodiments, however, the database 120 may be an external data storage unit (for example, a cloud-based data storage) that is communicatively coupled to the third party system 102 for storage and retrieval of data. In certain embodiments, the database 120 may be implemented in software alone, or as a combination of hardware (for example, physical storage/memory) and software that manages the hardware (for example, a database management application). Additional architectural details of the third party system 102 are provided later with reference to discussion of FIG. 7.

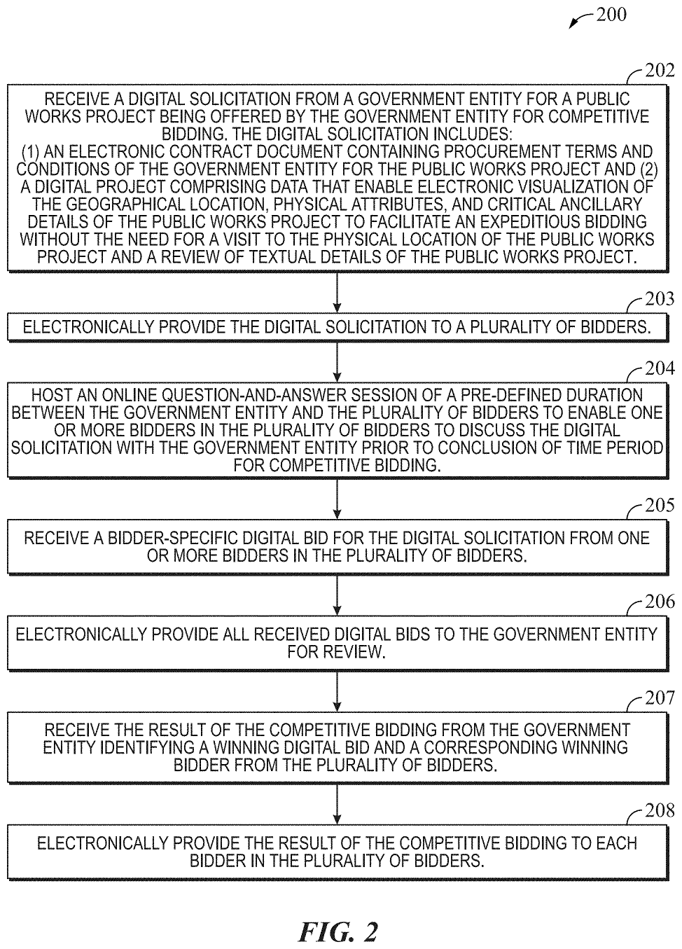

As noted above, the bidding application 114 may be a software application comprising program code, which, upon execution by a processor (not shown) in the host system 102, enables the host system 102 to perform different operations to facilitate digital project-based competitive bidding, and also to offer an online, web-based platform to enable a potential bidder to communicate with a government buyer through the online platform. An exemplary set of such operations is illustrated in FIGS. 2 and 4, which are discussed later below. More generally, the bidding application 114, upon execution, may enable the host system 102 to receive, store, and analyze the content received at arrow 110 and also from other sources (such as, for example, from a user affiliated with the third party bid manager, from an external website or data provider, and the like); responsively manage competitive bidding, for example, through a browser (not shown); and offer an online platform that allows a supplier/bidder to communicate with the government entity (buyer), for example, through the browsers of respective systems 104, 106. In some embodiments, the host system 102 may function as a “server”, whereas the government system 104 and the bidder system 106 each may function as a “client” of the host system 102. It is noted, however, that the client-server based arrangement is only one example of how the competitive bidding methodology of the present disclosure may be implemented. In some embodiments, the functionality of the bidding application 114 may be implemented in a non-server system as well. The non-server system may be associated with an entity or system providing a web-based bid management facility to remote buyers and interested suppliers. Furthermore, in certain embodiments, the functionality of the digital bidding application 114 may be implemented in an online cloud environment.

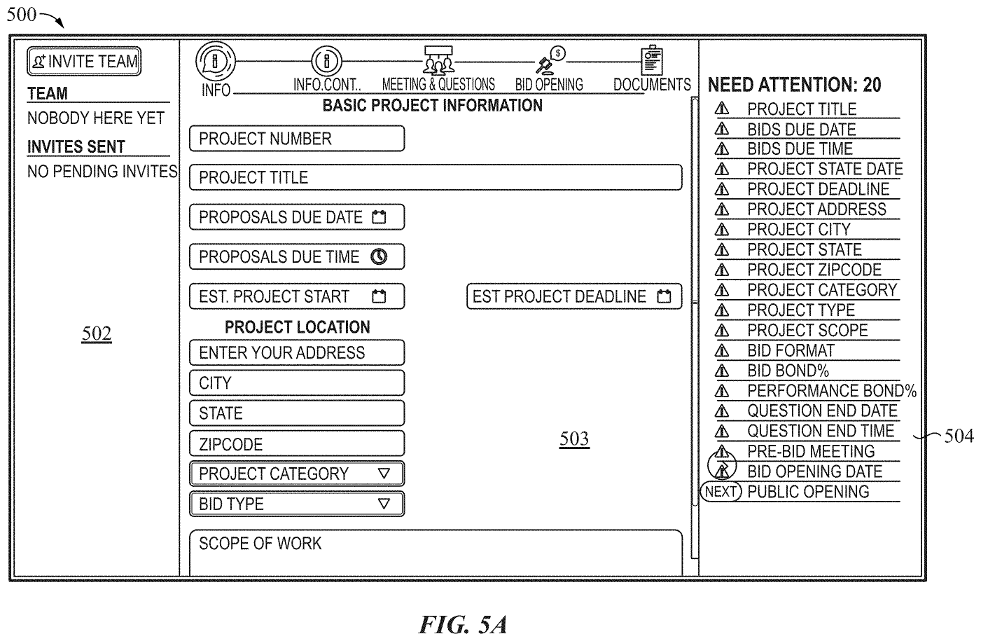

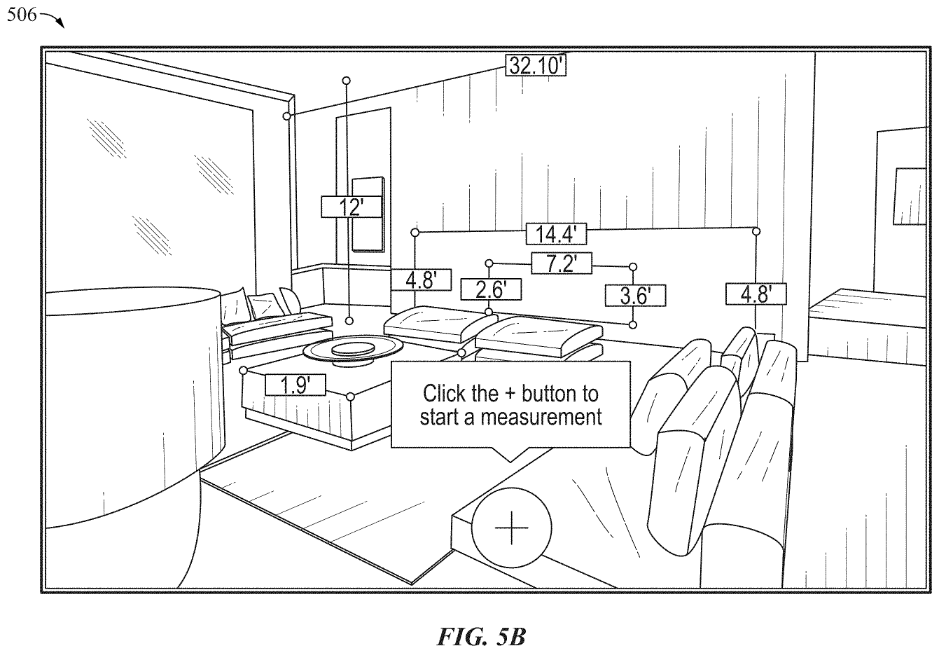

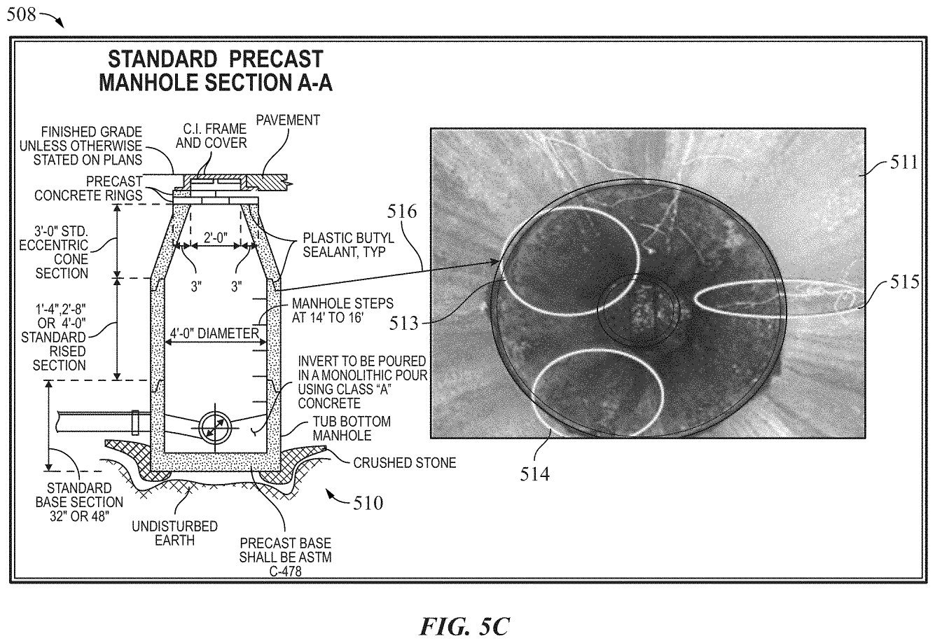

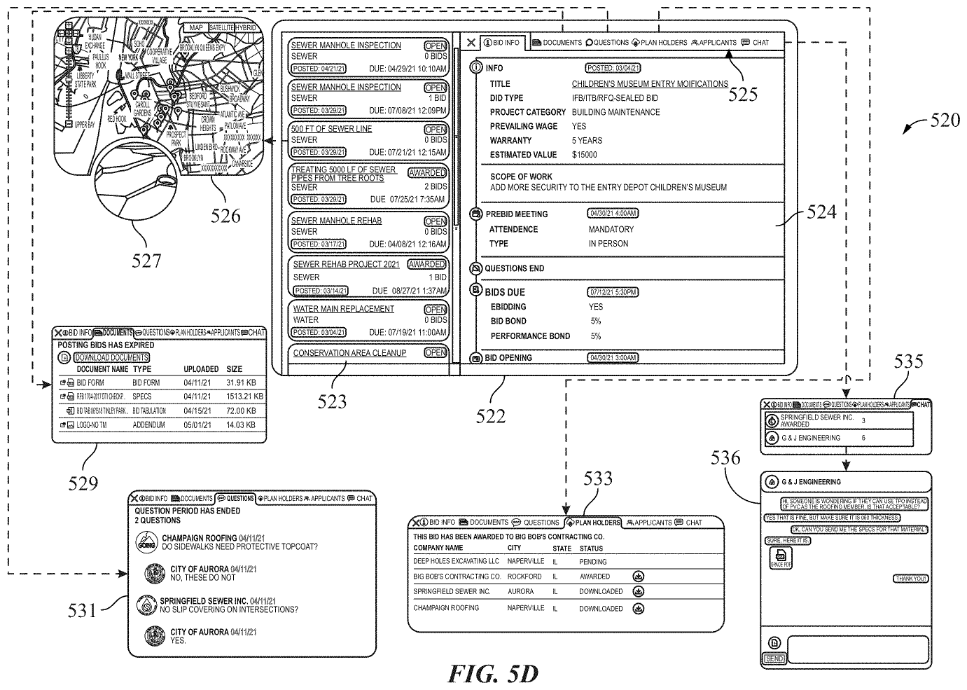

The program code constituting the bidding application 114 (which includes the software modules 116, 118) may be stored in a storage unit or memory (not shown) in the host system 102. Such memory, processor, and other exemplary architectural details of the host system 102 are shown in FIG. 7 and discussed later below. In one embodiment, at least a portion of the program code for the bidding application 114 may be based on Open Source Software (OSS). In some embodiments, the bidding application 114 may be associated with one or more computing systems (not shown) managed by a web server that coordinates content delivery to/from these computing systems to the systems 104, 106 via a common website offered by the third party bid manager. The architectural configuration, layout, appearance, or content of such a website (accessed by the users of the systems 104, 106) are not relevant to the present disclosure and, hence, except for the exemplary screenshots of FIGS. 5A-5D, no additional details thereof are provided here. Similarly, additional architectural details of the systems 104 and 106 are also not relevant to the present disclosure and, hence, are not shown in FIG. 1 for the sake of brevity and ease of illustration.

In some embodiments, the third party system 102, the government system 104, and the bidder system 106 each may be a computing system. A computing system generally processes, compiles, stores, and/or communicates information or data for business, personal, or other purposes thereby allowing users or operators of the system to take advantage of the value of the information. Because technology and information handling needs and requirements vary between different users or applications, computing systems may also vary regarding what information is handled, how the information is handled, how much information is processed, stored, or communicated, and how quickly and efficiently the information may be processed, stored, or communicated. The variations in computing systems allow for computing systems to be general or configured for a specific user or specific use such as financial transaction processing, airline reservations, enterprise data storage, or global communications. In addition, computing systems may include a variety of hardware and software components that may be configured to process, store, and communicate information and may include one or more computers, data storage systems, and networking systems.

Modern computing systems include many different types of consumer and commercial electronic devices such as, for example, personal computers (e.g., desktops or laptops), tablet computers, mobile devices (e.g., personal digital assistants (PDAs) or smart phones), corporate (or small business) server and data processing systems (e.g., blade server or rack server), a network storage device, and the like. These devices may vary in size, shape, performance, functionality, and price. In any event, almost all of these modern devices are equipped with relevant hardware and software to allow their users/operators to access a number of different websites over the Internet and perform online transactions.

For purpose of this disclosure, a computing system may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. The computing system may include random access memory (RAM), one or more processing resources such as a central processing unit (CPU) or hardware or software control logic, read-only memory (ROM), and/or other types of nonvolatile memory. Additional components of the computing system may include one or more disk drives, one or more network ports for communicating with external devices as well as various input and output (I/O) devices, such as a keyboard, a mouse, touch-screen and/or video display. The computing system may also include one or more buses operable to transmit communications between its various hardware components.

In one embodiment, a supplier/bidder or its representative may use the bidder system 106 to access a website associated with the third party system 102 using the corresponding website address in a web browser (not shown) running on the bidder system 106. A government entity (buyer) or its representative also may similarly access the website hosted by the third party system 102 using a web browser (not shown) running on the government system 104. FIGS. 5A-5D show some exemplary screenshots that may be generated and/or displayed in a web browser by the third party host's website. It is noted here that the program code for a web browser may be stored in a memory (not shown) of the respective system 104, 106, and may be executed by a processor (not shown) in the respective system 104, 106 under operative control of a respective Operating System (OS). Similarly, the program code for the bidding application 114 may be stored in a memory (not shown) in the BMS system 102 and executed by a processor (not shown) in the BMS system 102 under operative control of a corresponding OS (not shown) of the BMS system 102. In particular embodiments, the bidding application 114 may configure the host system 102 to offer the website to provide an online, web-based platform for the buyer (here, a government entity) and supplier (here, a bidder or contractor). In particular embodiments, the OS of each of the systems 102, 104, 106 may be a Microsoft® Windows® based operating system (such as, for example, Windows XP, Windows 7, 8, or 10, and Windows NT operating systems). In other embodiments, each system 102, 104, and 106 may have a different operating system, which may not be a Microsoft® Windows® based operating system.

In certain embodiments, the bidding application 114 in the host system 102 may cause the host system 102 to display a web page to the government system 104 through a browser (not shown) to enable the government entity to electronically submit relevant details and data for its public works project (for which competitive bidding is sought) to the system 102 to enable the bidding application 114 to facilitate generation of a digital solicitation for the public works project and implementation of competitive bidding using software modules 116, 118 as discussed in more detail later below. Information from the bidder system 106 also may be received in a similar manner. In that regard, the host system 102 may display the web page with a number of different fields to be filled-in by the buyer (government entity), the seller (bidder), or their representatives, or present a plurality of questions to the buyer and/or seller through the web page and receive a corresponding answer for each question, or receive/retrieve certain electronic documents and digital media files from the government system 104 and/or the bidder system 106, or perform a combination of these acts to obtain the information necessary for competitive bidding as per teachings of the present disclosure. In particular embodiments, the bidding application 114 may provide a wizard (through a browser on the systems 104, 106) (not shown) that asks the buyer (or its representative) and the supplier (or its representative) various questions to obtain relevant information from them.

In certain embodiments, to facilitate a supplier's or a buyer's access to the website hosted by the host system 102, the web browser (not shown) in the respective system 104, 106 may communicate with the host system 102 using a request-response messaging scheme based on the Hypertext Transfer Protocol (HTTP) or the Hypertext Transfer Protocol Secure (HTTPS) if the host-based website is offering an HTTPS-based communication for secure browsing experience. In particular embodiments, the information/data communicated between the host system 102 and either of the systems 104, 106 may be in the form of an Extensible Mark-up Language (XML) object.

FIG. 2 shows an exemplary flowchart 200 depicting various steps that may be performed by a computing system as per particular embodiments of the present disclosure to facilitate digital project based competitive bidding as per teachings of the present disclosure. In one embodiment, the computing system may be the third-party system 102, which may include in hardware and/or software the functionality of the bidding application 114 containing the software modules 116, 118. In one embodiment, the program code for the modules 116, 118 (and other relevant program code such as the program code for the OS of the computing system 102) may be executed by a processor (not shown) in the computing system 102 and, upon execution of the program code, the computing system 102 may be operative to perform the tasks illustrated in FIG. 2. It is observed that the tasks 202-208 illustrated in the flowchart 200 provide an outline of how a substantially fully-digital procurement process for government contracts may be implemented as per teachings of the present disclosure to expeditiously fulfill a government entity's procurement needs within a geographical location in a fair and competitive manner.

In the flowchart 200, each block represents one or more tasks that can be implemented in hardware, software, or a combination thereof. In the context of software, the blocks represent computer-executable instructions that, when executed by one or more processors, cause the processors to perform the recited tasks. Generally, computer-executable instructions include routines, programs, objects, modules, components, data structures, and the like that perform particular functions or implement particular abstract data types. The order in which the blocks are described is not intended to be construed as a limitation, and any number of the described tasks can be combined in any order and/or in parallel to implement the process shown in the flowchart 200. For discussion purpose, the process in the flowchart 200, is described with reference to FIG. 1 as described above, although other models, frameworks, systems and environments may be used to implement this process.

Initially, as noted at block 202, the computing system (for example, the host system 102 in FIG. 1) may receive a digital solicitation from a government entity (for example, from the government system 104) for a public works project being offered by the government entity for competitive bidding. Some examples of public works projects include repair of a roof of a public school, installation of sewage pipelines, construction of a community hall, pavement of a segment of a road, building of a bridge, and so on. In some embodiments, the public works project also may include construction, maintenance, and repair work of public infrastructure items (such as, for example, roads, bridges, wharfs, tunnels, railway tracks, and so on). As noted at block 202, the digital solicitation may include: (1) an electronic contract document containing procurement terms and conditions of the government entity for the public works project, and (2) a digital project comprising data that enable electronic visualization of the geographical location, physical attributes, and critical ancillary details of the public works project to facilitate an expeditious bidding without the need for a visit to the physical location of the public works project and a review of textual details of the public works project. The creation of a digital project as per teachings of the present disclosure is discussed later with reference to FIG. 4.

As mentioned before, in some embodiments, a human representative of the government entity may access a website hosted by the third party system 102 using the government system 104 and submit the contents of the digital solicitation using a web browser (not shown) on the government system 104. The computing system (for example, the third-party system 102) may electronically provide the received digital solicitation to a plurality of bidders (block 203). As discussed later, in some embodiments, the users or representatives of potential bidders may use the respective bidder systems 106 to receive the solicitation (for example, as an e-mail) or to retrieve the solicitation online from the third party's website using a web browser (not shown). At block 204, the computing system may host an online question-and-answer session of a pre-defined duration between the government entity and the plurality of bidders to enable one or more bidders in the plurality of bidders to discuss the digital solicitation with the government entity prior to conclusion of time period for competitive bidding. In particular embodiments, the pre-defined duration for the online question-and-answer session may be established by the government entity and may terminate prior to the conclusion of the time period for competitive bidding. In certain embodiments, the government entity may not offer such a question-and-answer session to discuss the details, scope, terms, and conditions of its digital solicitation. In any event, the computing system may receive a bidder-specific digital bid for the digital solicitation from one or more bidders, as noted at block 205. In some cases, all bidders in the plurality of bidders may respond with digital bids. In other cases, some bidders may respond, and some may not. In particular embodiments, the bids may be received during the time allotted for competitive bidding (for example, 7 days, one month, 72 hours, and the like) by the government entity.

At block 206, the computing system may electronically provide all received digital bids to the government entity for review. As discussed later, in some embodiments, a representative of the government entity may use the government system 104 to receive the bids (for example, as e-mails) or to retrieve the bids online from the third party's website using a web browser (not shown). Subsequently, the authorized personnel of the government entity may review the received digital bids and make a decision as to which bidder should be avoided the government contract. At block 207, the computing system 102 may receive the result of the competitive bidding from the government entity (for example, via the government system 104) identifying the winning digital bid and a corresponding winning bidder from the plurality of bidders. Consequently, the computing system may electronically provide the result of the competitive bidding (received at block 207) to each bidder in the plurality of bidders. The result may be electronically provided in a manner similar to that discussed before with reference to block 203—such as, for example, as an e-mail or on a web page of the third party's website.

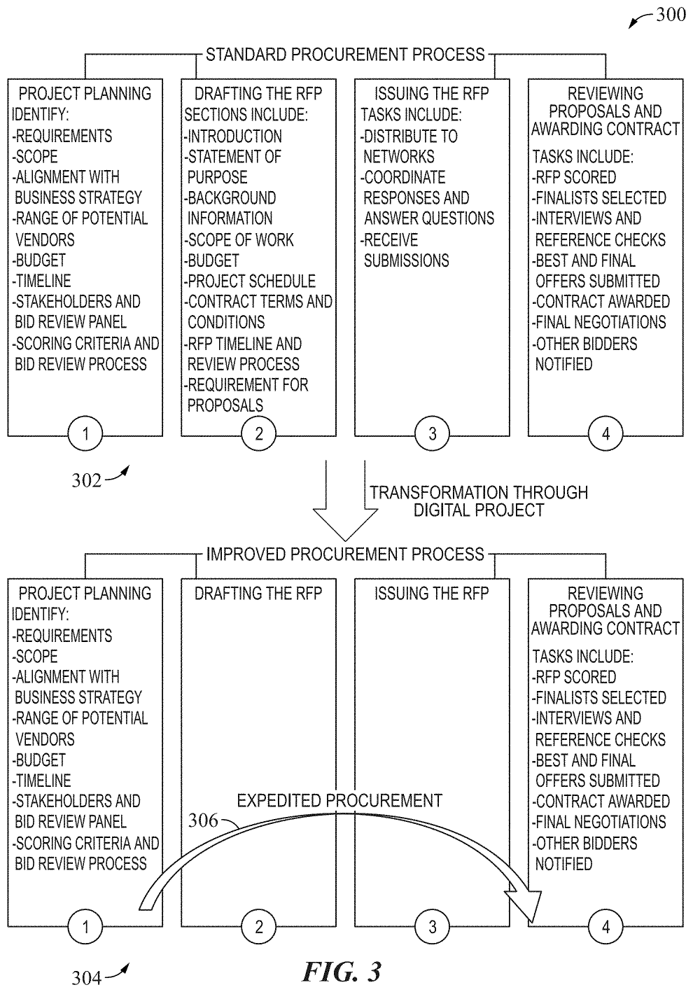

FIG. 3 is an exemplary illustration 300 of how digital projects may improve a competitive bidding-based procurement process. As mentioned before, the creation of a digital project as part of generation of a digital solicitation is discussed in more detail later with reference to FIG. 4. In the context of FIG. 3, the reference numeral “302” is used to refer to a standard (or traditional) procurement process that does not involve digital projects. On the other hand, the reference numeral “304” is used to refer to an improved procurement process that results from the transformation of the standard procurement process through the use of a digital project (generated as per the teachings of the present disclosure). Typically, as shown in FIG. 3, the standard procurement process 302 may include four general stages identified by circled numbers “1” through “4.” The first stage is identified as the “Project Planning” stage, the second stage is identified as the “Drafting the Request for Proposal (RFP)” stage, the third stage is identified as the “Issuing the RFP” stage, and the fourth stage is identified as the “Reviewing Proposals and Awarding Contract” stage. In the first stage, the buyer (for example, a government entity) may identify, for example: the requirements to be fulfilled through competitive bidding, the scope of work for the project to be offered through competitive bidding, how the project is aligned with the buyer's business strategy, the range of potential vendors qualified to bid on the project, the budget to be allocated for the project, the timeline for completion of the project, the stakeholders and members of the bid review panel, and the criteria to be used to score the bids and the steps involved in the bid review process. Based on the project planning, the buyer may draft the RFP in the second stage of the process 302. Some exemplary sections in the RFP may include: an introduction of the project, a statement of purpose giving outline of the project, a background section containing information relevant to the project, a scope of work section detailing the requirements of the project, a project schedule section informing the bidder about the potential timeline or milestones of the project, terms and conditions of the contract, the timeline for the RFP submissions and details of the bid review process, and the requirements to be complied by the submitters (or bidders) of the proposals.

In the RFP issuance stage (the third stage) of the process 302, the buyer may distribute the RFP to potential networks of sellers (for example, suppliers or building contractors), coordinate the responses received from the sellers, answer questions from sellers (if any), and receive bid (or RFP) submissions from the sellers. Finally, in the fourth stage, the buyer may score each bidder's RFP (or competitive bid), select a group of finalists, interview the selected finalists and check their background references, receive the best and final offers submitted by the finalists, review the final offers and award the contract to a winning bidder, carry out final negotiations with the winner of the competitive bidding, and notify other bidders of the results of the bidding and award of the contract.

The above-described standard procurement process 302 broadly represents the current approach for solicitation of bids for government contracts. As discussed earlier, the current approach is antiquated, cumbersome, wasteful, error-prone, inefficient, and environmentally unfriendly. For example, there is still a heavy reliance on printing and mailing of a large number of documents, resulting in a significant (and, absolutely unnecessary) delay in fulfilling a solicitation. The printing, mailing, and review of documents related to request for proposal (RFP), bid information, bid qualifications, and quotes is an incredibly challenging process that costs billions in taxpayer funds and wastes millions of human hours in trying to find, respond, advertise, and plan procurement solicitations.

However, in particular embodiments, the standard procurement process 302 may be transformed into the improved process 304 through the use of digital projects. The creation of a digital project is explained in more detail with reference to FIG. 4. A digital project may transform the traditional procurement process 302 into a substantially fully-digital procurement process in which all the four stages of procurement solicitation—the project planning stage, the RFP drafting stage, the RFP issuance stage, and the proposal review and contract award stage— may be streamlined using advanced media technology (deploying audio and visual features) to significantly expedite the procurement process. In FIG. 3, such expeditious execution of the procurement process is illustrated by the exemplary arrow 306. The details of each stage in the improved process 304 are identical to those in the standard process 302. However, for the sake of brevity and ease of illustration, textual contents of stages 2 and 3 are not shown in the improved process 304. Thus, for example, various documents (such as RFPs, bids, contracts, terms and conditions, and the like) may be created in a digital format, the buyer may generate a digital solicitation with audio and/or visual explanation of the project, the bidder may electronically chat with the buyer to shorten the time period for information exchange, and so on. As a result of such fully-digital approach, the improved process 304 may be concluded in a fair and competitive manner in hours or days versus the months currently needed to complete the standard process 302. Furthermore, waste (of time and taxpayer funds), corruption, collusion, and environmental damage may be significantly reduced as well.

FIG. 4 depicts an exemplary flow of tasks 400 associated with a government entity 402 and a bidder 404 to implement the competitive bidding methodology as per particular embodiments of the present disclosure. Generally, the block 402 may represent any “buyer” (for example, a home owner) and the block 404 may represent any “seller” (for example, a roofing contractor) taking part in a digital project-based competitive bidding as per teachings of the present disclosure. However, for ease of description, interactions between a government entity as a buyer and a bidder (or contractor/supplier) as a seller in a competitive bidding for a public works project are shown and discussed with reference to FIG. 4. Furthermore, for simplicity of drawing and ease of discussion, only one bidder 404 is shown in FIG. 4. However, as noted before, it is understood that there may be more than one bidder taking part in the competitive bidding. The discussion below in the context of the single bidder 404 remains equally applicable to all other bidders (not shown) associated with the competitive bidding.

The government entity 402 and the bidder 404 may interact with a respective software module 116, 118 in the bidding application 114 (through respective systems 104, 106), as illustrated in the exemplary embodiment of FIG. 4. Thus, the tasks 406, 411, 413, 415, 422, 428, 431-432, and 437 associated with the government entity 402 may be fully or partially performed by the government entity using the government system 104, and, similarly, the tasks 408-409, 411, 419, 422, 424, and 434-435 associated with the bidder 404 may be fully or partially performed by the bidder using the bidder system 106. Furthermore, it is observed that, in particular embodiments, some of the tasks shown in FIG. 4 may be performed with the help of a human—such as, for example, a representative of the government entity 402 or a user affiliated with the bidder 404—as may be evident from the discussion below. In some embodiments, instead of a single human, a group of human operators may perform a task. However, for ease of discussion, the reference numerals “402” and “404” are used in the discussion of FIG. 4 to more generally refer to the government entity and the bidder, respectively, without using separate reference numerals for humans associated with the government entity and/or the bidder. In other words, in the discussion of FIG. 4, a reference to a task performed by the government entity 402 may mean that the task is performed by a human and/or the government system 104, and, similarly, a reference to a task performed by the bidder 404 may mean that the task is performed by a human and/or the bidder system 106, as may be evident from the context of discussion.

It is noted that if two tasks (for example, tasks 406 and 408) are shown horizontally-aligned or if two arrows (for example, arrows 417 and 420, or arrows 426 and 429) are shown linearly-aligned, it does not necessarily mean that the tasks or relevant acts are performed in parallel (or simultaneously). The illustration 400 in FIG. 4 is exemplary in nature; it does not imply any specific order of execution of tasks. Furthermore, as in case of the tasks in FIG. 2, any number of the tasks shown and described with reference to FIG. 4 can be combined in any order and/or in parallel to implement the digital project-based competitive bidding as discussed herein.

Initially, at task 406 in FIG. 4, the government entity 402 may create a user profile (in digital form) at the website (not shown) hosted by the third party. The government entity 402 may use a browser (not shown) in the government system 104 to access a User Interface (UI) thereof to open the Uniform Resource Locator (URL) link (or web address) of the website (or portal) hosted by the third party (through the BMS system 102 in FIG. 1). Once at the website, the government user 402 may create an online account (which may have a username and may be password-protected) as a buyer and complete the online profile by providing relevant buyer-specific information to the government module 116 in the third party system 102. The BMS system 102 (upon execution of the bidding application 114) may display a web page at the government-accessed portal with a number of different fields to be filled-in by the government user, or present a plurality of questions to the government user 402 through the web page and receive a corresponding answer from the user 402 (using the government system 104) for each question, or retrieve relevant information from the government system 104, or perform a combination of these acts to obtain the relevant information to create a user profile for the government entity 402. Similarly, at task 408, the bidder 404 may create a user profile (in digital form) at the third party's website (not shown) by, for example, using a browser (not shown) in the bidder system 106 to access a UI of the browser to open the URL link (or web address) of the website (or portal) hosted by the third party. Once at the website, the bidder's representative 404 may create an online account (which may have a username and may be password-protected) as a seller and complete the online profile by providing relevant seller-specific information to the bidder module 118 in the third party system 102. The BMS system 102 (upon execution of the bidding application 114) may display a web page at the bidder-accessed portal with a number of different fields to be filled-in by the bidder's representative, or present a plurality of questions to the bidder's representative 402 through the web page and receive a corresponding answer from the representative 402 (using the bidder system 106) for each question, or retrieve relevant information from the bidder system 106, or perform a combination of these acts to obtain the relevant information to create a user profile for the bidder 404.

Profiles may be created to allow government entities (buyers) to advertise their solicitations on one platform and to allow registered (or subscribed) businesses (sellers) to easily see these bid solicitations, giving governments an advantage to offer their solicitations to more businesses than is possible under traditional approach of mailing solicitation documents via postal mail. The profiles may enable businesses to show their information about their companies and be searchable via a geographical location on a map. Governments can search for types of businesses that would meet their solicitation requirements and invite them to a private or public bid solicitation. The government entity may search for candidate businesses (for competitive bidding) by a keyword search based on the keywords selected by the companies during the set up their profiles. As noted at task 409, using the bidder module 118, the bidder 404 may have an option to select or set-up a number of different keywords based on services, products, or materials the bidder uses or sells. The keywords may allow buyers (here, the government entity 402) to find bidder information through a search feature on the third party's website. A bidder's profile also may contain keywords selected by the bidder indicating the bid preference of the bidder. Some exemplary keywords may be, for example, “minority owned,” “women owned,” “disadvantaged neighborhood,” “low income locality,” “manhole,” “grout,” “chimney,” “sewer,” “rehabilitation,” “repair,” and so on.

Profiles may contain certain pieces of information about the bidder 404 or the government entity 402 such as, for example, contact details, physical address of the bidder, an indication of geographical service area of the bidder, and the details of the department leader of the relevant procurement department of the government entity. The bidder profiles may include a main company profile (for example, a general contractor's profile) as well as any sub-company profiles (for example, profile of a sub-contractor working with the general contractor). All main and sub profiles may have details and user ratings associated with them. For example, a bank may have branches across the mid-west. A government entity or other buyer in that region may be looking for a loan. They can search for a suitable lender/bank on the third party's website (hosted by the BMS system 102) via a map and GIS locations of different banks in the geographical region of interest. They could invite the appropriate mid-west branch of that bank as well as other banks to a solicitation for a loan. They can reach out to selected banks by phone, direct message, chat system, or by a digital invite to the respective bank's contacts posted on their profiles. If a business is a minority-owned business or is located in a disadvantaged neighborhood, for example, the government entity may find it through the keywords in the business's profile and invite it to respond to the government's solicitation or quote request.

At task 411, the bidding application 114 may enable the host system 102 to provide an online platform to facilitate digital planning of the government entity's solicitation. The online platform may allow the government entity to communicate with potential bidders and also with one or more professional affiliates of the government entity (such as, for example, architects or engineers assisting the government entity in defining the scope of work or guidelines for the public works project to be offered for competitive bidding). In one embodiment, the online platform may enable the professional affiliate to assist the government entity in planning the public works project and/or in creating the eventual digital solicitation. Similarly, in another embodiment, the online platform may enable one or more bidders to assist the government entity in planning the public works project and/or in creating the digital solicitation. It is noted that, in some embodiments, the digital planning phase 411 may be optional.

The communication during the digital planning phase 411 may be established via audio, visual, or text feature allowing government entities to plan projects, plan supply chain management, plan buying of goods and services, coordinate among local communities to develop consortiums among government entities from different communities. This communication may be performed by voice calls, video calls, text messaging, media and file sharing in private chats, as part of online communities, on a channel-based messaging system, or an audio-based social media app to improve and streamline project and procurement processes within governments.

During the digital planning phase 411, communication planning rooms may be established by an administrator or manager of the third party system 102, or permissions for such communication may be granted within the bidding application 114. As noted before, user profiles (tasks 406, 408) may be established for buyers and sellers that include contact information, locations, names of executive leaders, and employees. The users within the profiles may establish their own profiles and connect with others in their industry creating a social media component allowing different users to join communication rooms in order to share information, collaborate, exchange resources, auction, advertise, manage supply chains and logistics, promote their products, services, equipments, and materials. The digital planning 411 may create a social environment to educate the government entities about what businesses are selling, advertising, promoting, and discounting, and also to educate the government entities about products, materials and services of potential bidders to create a more competitive bidding environment.

In particular embodiments, during digital planning 411, government entities and private sector entities (for example, architects, engineers, or other consultants affiliated with or advising a government entity) may create digital consortiums with potential bidders to educate, collaborate, and share budget information to add more cost savings. This may also improve the revenue of the bidders (contractors and suppliers) by allowing them to consolidate their crews and supplies in a particular geographical area to optimize their crews' performances. This, in turn, may reduce the government entity's procurement cost. Furthermore, based on the information exchange during the planning phase 411, the bidders may become aware of the government entity's budget and the total work available in a particular geographical area. Many bidders (contractors and suppliers) can form a group or consortium to jointly offer one bid in response to the government's solicitation. All contractors and suppliers in a group or consortium may benefit by getting a share of the workload available in a particular area. This may stimulate local economies and increase the competitive environment to improve workmanship.

In particular embodiments, the online planning rooms (as part of the digital planning task 411) may allow governments and their engineers to discuss and work on building a project together without the use of emails. As mentioned before, these planning rooms also can be used by potential bidders (including businesses, subcontractors, general contractors, suppliers and manufactures) to discuss their responses to a project posted by a government entity. The digital planning rooms also may be used to share important electronic documents, electronically fill out documents (autofill), share encrypted documents, videos, media, pictures, Light Detection and Ranging (LIDAR) or 3D modeling of images like infrastructure or assets of a buyer's (business or government entity) property, and so on. The access to a digital planning room may be offered to authorized personnel and may be secured by, for example, passwords, encryptions, personal identification numbers (pin), biometrics, facial recognition, or other types of digital protection to plan for public works projects, purchases, logistics, supplies and other forms of procurement. In some embodiments, the planning rooms may have a social media type structure to them. The planning rooms may be used for audio communication, voice over IP (VOIP) communication, and/or text messaging. The planning rooms also may be used as a place for government's public works departments to talk to or communicate with their crews (for example, as crews upload images of broken roadways) to plan a project to be solicited for repairs or replacements. The process also allows government users to direct purchase (micro purchasing) of products/services and communicate with their contractors or suppliers via the planning rooms.

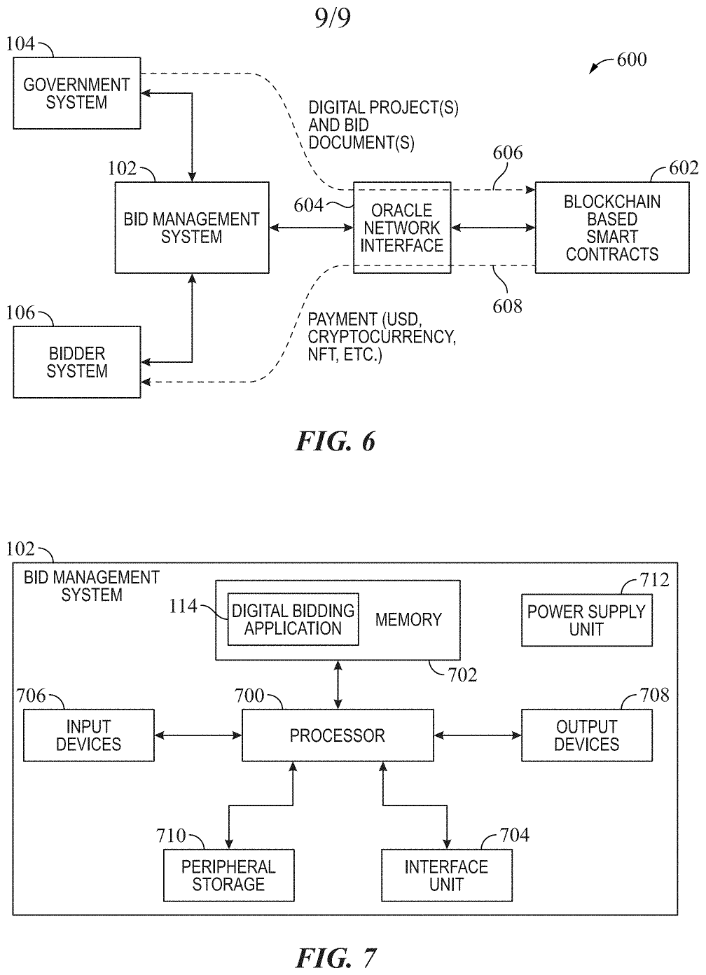

At task 413, the government entity 402 may create a digital project based on the digital planning 411. The digital project may comprise data that enable electronic visualization of a geographical location, physical attributes, and critical ancillary details of the public works project to facilitate an expeditious bidding without a need for a visit to a physical location of the public works project and a review of textual details of the public works project. In particular embodiments, as illustrated by arrow 414, the government module 116 may provide (through the website hosted by the third party system 102) online tools (for example, a web link, an API, a software download, and the like) to the government entity to assist the government entity in creating at least a portion of the digital project. Such online tools may include access to a digital image capture software, a digital twin generation application, an annotation utility, a GIS mapping source, and the like. In some embodiments, a digital project may be created by the government entity 402 by including all electronic documents, pictures, videos, 3D images, holograms, LIDAR images, laser or 3D spatial data, or other form of images (such as digital twins) related to the public works project being offered for competitive bidding. In other embodiments, the digital project for the subject matter of government solicitation may be created using 3D building information models or box modeling, polygon modeling, non-uniform rational basis spline (NURBS) and curve modeling, digital 3D sculpting, photogrammetry, simulation, procedural modeling, boolean modeling, and so on. In one embodiment, the digital project may be stored in the form of a smart contract (as discussed later with reference to FIG. 6).

A digital project may be built to store the asset information in the digital form and associate it with a geographical location (for example, as a GIS or GPS location). The digital project may be stored as a file or blockchain process, and may represent the digital information of a physical location as described in a digital document (such as, for example, an electronic contract document containing procurement terms and conditions of the government entity for the public works project). Broadly, a digital project may be a digital asset that has information built into that digital asset that can be competitively bid on.

For example, robotic cameras, laser scanners, regular digital cameras, or other 3D modeling devices for inspection of manholes may be used by government personnel (or others affiliated with the government entity) to produce images and locations of defects in the public works infrastructure. The outputs of these devices may generate Building Information Modeling (BIM) data which can be used for the digital project. In one embodiment, the government module 116 may provide a link or web access to the website of a service provider (such as, for example, the technology offered at https://rapidview.com) to enable the government entity 402 to engage the services of the provider or rent/lease the equipments from the provider to create the necessary digital images of its public works project. In particular embodiments, a digital twin of a public works project may be generated by the government entity 402. A digital twin is a digital representation of a physical object, process or service. A digital twin may be a computer program that uses real world data to create simulations that can predict how a product or process will perform. A digital twin may be considered as a digital copy of a real-world place or object. Artificial intelligence and machine learning technologies enable the creation of digital twins, which are dimensionally accurate 3D digital models that can be updated quickly to reflect changes with its physical counterpart. Use of such technology, which creates a digital representation of real-world systems and components, may be important for a potential bidder to visualize the tasks to be performed for the public works project offered by the government entity before the bidder submits its bid.

In particular embodiments, the host system 102 may provide the government entity with an access to an entity that can produce digital twins (such as, for example, the digital twin generation offered at www.matterport.com). In other embodiments, the host system 102 itself may provide the necessary software (for example, as a digital download link or file transfer protocol (FTP) link) to generate digital twins from the digital images of the physical location, item, or public works project. For example, a digital twin or a 3D model of a government building may include all its infrastructure information such as, for example, high voltage AC (HVAC) install date, plumbing services, materials, mortgage information (if any), deeds, insurance information, and so on. Bidders (for example, building managers) can use digital twins to understand why things were engineered and designed in the manner they were, and this understanding translates to simplified maintenance. For example, maintenance technicians called in to repair a broken water pump in the government building can utilize the digital twin to understand the design and intent of the pump. They can see the bigger picture, not just the broken pump in front of them. In one embodiment, digital twins and all other information comprising a digital project can be attached to a digital asset (for example, the electronic contract document of the public works project offered for bidding) and competitively bid on.

In some embodiments, a digital project may include a number of standardized construction codes relevant to the public works project and embedded with visual aids identifying the public works project. For example, the National Association of Sewer Service Companies (NASSCO) may offer standardization guidelines and certifications as part of its Pipeline Assessment Certification Program (PACP), Lateral Assessment Certification Program (LACP), and Manhole Assessment Certification Program (MACP) as explained in more detail at www.nassco.org. In particular embodiments, the bidding application 114 may enable the government entity 402 to use the NAASCO codes into its digital project so that bidders or contractors can competitively bid on the solicitation. As mentioned before, a digital project created by the government entity 402 using the digital images, videos, geospatial locations, and other visual technology may be embedded with such codes.

Thus, at task 413, the government entity 402 may use media files, camera annotations, digital videos, asset management links, APIs, FTP links, digital links, software downloads, digital camera images, drone videos/images, LIDAR images, Artificial Intelligence (AI) software, augmented reality (AR), 360° video, virtual reality (VR), augmented mixed reality, other 3D camera technology, GIS data (asset management software), and other digital content associated with the public works project to create a digital project that allows bidders (for example, contractors and suppliers) to easily visualize the details of the public works project or tasks necessary to complete the public works project, and competitively bid on the government's solicitation. The creation of a digital project can thus significantly reduce the amount of time currently needed to plan, prepare, and create a request for information, qualifications, proposals, quotes, estimate, and competitively bid for a contract and/or agreement of any kind to execute a purchase for services or goods. The digital project may be created using a desktop, laptop, mobile phone, or mobile app, allowing the users of the government system 104 to upload videos and images, use annotations and measurements of a project needing repairs, send the images, videos or dictations of the project directly to the contractors and suppliers to quickly receive quotes for the government's request/solicitation.

More generally, a digital project for a public works solicitation may be a combination of the following: (i) an annotated digital image of the public works project, (ii) a digital twin generated from pictures associated with the public works project, (iii) a 3D digital model of the public works project, (iv) a digital video related to the public works project, (v) a digital audio recording related to the public works project, (vi) a GIS location data for the public works project, (vii) a drone footage of the public works project, (viii) a geospatial location information for the public works project, (ix) a link to a digital media file containing data about the public works project, (x) a plurality of standardized construction codes relevant to the public works project and embedded with visual aids identifying the public works project, and (xi) electronic documents providing constructional details of the public works project.

At task 415, the government entity 402 may submit its digital solicitation to the government module 116, which, in turn, may share the contents of the solicitation with the bidder module 118 as indicated by arrow 417. In particular embodiments, the digital solicitation may include: (i) an electronic contract document containing procurement terms and conditions for the public works project, and (ii) the digital project created at task 413. A user of the government system 104 may log into the online platform hosted by the third party system 102 to upload the contents of the digital solicitation into the system 102. In one embodiment, the bidder module 118 may analyze the digital solicitation to determine the keywords contained therein, compare the keywords in each qualified bidder's profile with the keywords extracted from the digital solicitation, and electronically provide the digital solicitation to only those bidders whose bidder-specific keywords match the solicitation's keywords beyond a pre-defined threshold (for example, a 70% match, a 90% match, and the like). In one embodiment, if the government entity has provided a geographical preference for its public works project (for example, a certain neighborhood in a city) in its user profile, the bidder module 118 may send the digital solicitation to only those bidders whose indication of geographical service area (as specified in the bidder's user profile) satisfies the geographical preference received from the government entity. In certain embodiments, the bidder module 118 may notify the qualified bidder of the reception of the digital solicitation from the government entity 402 via phone call, email, text message on a bidder's mobile phone, app notification, a system message in the bidder's user profile, and the like. At task 419, the bidder 404 may retrieve the contents of the solicitation (from the bidder module 118) by logging into the third party's online platform or the bidder 404 may automatically receive the contents from the bidder module 118, for example, into a designated e-mail account of the bidder 404, as indicated by the bi-directional arrow 420 in FIG. 4.

In some embodiments, the bidder 404 may find a procurement solicitation via a GPS or geospatial (GIS) location on a map displayed on the third party's website as per the search terms of the bidder 404. For example, the bidder 404 may search for procurement opportunities currently available in a specific zip code. The map may give the bidder 404 alerts or visual aids (images, media files, documents or videos) in finding bid solicitations that meet their geographical preference and business needs. The keyword-matching and map-based searching for matching bid solicitations may give the bidder an opportunity to find and respond to bid solicitations quicker by clicking on bid information “posted” on a pin or location on a mapping system by the bidding application 114. The bid solicitation information visibly “posted” on a GPS or GIS location allows for bidders to open the details of the advertised solicitation into their web browsers, giving them the ability to download documents, images, links, or any information associated with the solicitation. The bidders can respond, get approved, communicate, become a plan holder, watch the bid details, bid and/or get rejected by the government entity.

In particular embodiments, the bidding application 114 may allow the government entity 402 to digitally create a summary of the procurement solicitation to be posted on a geographical location (for example, within a specific zipcode, at the actual location of the site of the public works project, and so on). The solicitation may have set dates, times, and requirements that inform the bidder of the duration the solicitation will remain open and how to timely bid on the solicitation. The contents of the digital project may allow the bidder to quickly generate its quote versus reading through hundreds of pages of bid solicitations. In certain embodiments, the solicitation summary may contain the project start and end dates, the warranty time period of goods and services, the bid bond percentages, the performance bond percentages, a virtual communication link (for example, a link for a video chat session using the Zoom™ app). The digital solicitation's summary may allow the bidder 404 to create a physical mailing location to submit physical documents or the government entity may choose to electronically fill out the documents on the third party's online platform, allowing document automation. The price schedule for different types of government solicitations may be automated as well. Thus, the third party's online platform (hosted by the system 102 in FIG. 1) may allow the government entity 402 to upload any electronic solicitation document and require the bidder to review it or fill it out online. The digital solicitation may provide the bidder access to the government entity's digital project containing digital videos, images, links to another database or cloud-based storage that would have visual information about the project.

The BMS system 102 allows the government entity 402 to advertise its solicitation on one platform, thereby allowing all registered or subscribed businesses (potential bidders) to easily see the solicitation. This approach gives the government entity 402 an advantage in finding more businesses to bid on their advertisements. As mentioned before, the bidders may set up a keyword system on their profiles associated with their services, materials and products. The bidding application 114 may analyze the titles, budget information, documents, images, videos, dictations, virtual reality, mixed reality, and any words or digital information contained in the government's solicitation to find the matching bidders. This allows qualified businesses/bidders to quickly see the request for quote, proposal, information, qualification, documents and other information in the solicitation. This may significantly increase the number of competitive bidders and their responses to digital solicitation, also may connect the bidders and the government entity faster and streamline the procurement process by 50% or more—from months to weeks, days, or hours. This also keeps the integrity of the procurement policies and laws in place and keeps the bidding process transparent, open, competitive, fair, and honest. Businesses can also advertise promotions and market their products via a visual map pin location feature allowing users/buyers to search by specific geographical range (for example, within 10 mile radius, or within 25 miles of a specific location) to find businesses that match their searching keywords.

At task 422, the bidding application 114 may enable the host system 102 to provide an online chat room to facilitate a question-and-answer session of a pre-defined duration between the government entity 402 and qualified bidders (including the bidder 404) to enable the bidder(s) to discuss the digital solicitation with the government entity prior to conclusion of time period for competitive bidding. In one embodiment, the pre-defined duration for the online question-and-answer session may be established by the government entity for a set period and dates (for example, 24 hours, everyday from 1 pm to 4 pm for one week from the issuance of solicitation, and the like) and may terminate prior to the conclusion of the time period for competitive bidding. In another embodiment, the bidding application 114 may offer options to the government entity 402 to setup and manage the online chat room. Once the time period has elapsed, the chat room 422 may close and no more questions can be asked. In one embodiment, once the project is awarded by the government entity 402, another chat room may open (on the third party's online platform) to allow the buyers and sellers to exchange documents or other information pertaining to a solicitation. In this manner, the information exchange may be transparent and easily managed in one location from start to finish. In some embodiments, the availability of chat room may be optional.

Similar to the communication during digital planning task 411, in some embodiments, the chat room 422 may allow participants to communicate with voice calls, video calls, text messaging, media and file sharing in private chats, as part of online communities, on a channel-based messaging system, or an audio-based social media app to discuss project requirements, network, equipment sharing, emergency communication, consortium planning, bulk purchase planning, respond, discuss proposals, estimates, and buying opportunities together. Thus, like the digital planning task 411 in which the government entity 402 can connect and communicate with other government entities and/or their project design companies like architects or engineering firms to develop a digital procurement solicitation, the chat room at task 422 allows the government entity 402 to communicate with potential bidders during the competitive bidding process to discuss any queries or suggestions bidders may have about government's digital solicitation. As noted earlier, however, the communication at task 422 may be cut off at the question-and-answer deadline established by the buyer. In one embodiment, the chat room 422 may allow all contractors and suppliers that are interested in the bidding on the government's solicitation to be notified of any addendums in a timely manner and also to see the questions and answers being posted by other competitors.

At task 424, the bidder 404 (and other qualified bidders) may send a bidder-specific digital bid for the government's digital solicitation using the bidder system 106. The bidder module 118 may receive the bid and internally share its contents with the government module 116 as indicated by arrow 426. The government module 116, in turn, may electronically provide all received digital bids to the government entity 402 for review. In certain embodiments, the government module 116 may notify the government entity 402 of the reception of the digital bid(s) via phone call, email, text message on a mobile phone, app notification, a system message in the government entity's user profile, and the like. At task 428, the government entity 402 may retrieve the contents of the bid(s) (from the government module 116) by logging into the third party's online platform or the government entity 402 may automatically receive the contents from the government module 116, for example, into a designated e-mail account of the government entity 402, as indicated by the bi-directional arrow 429 in FIG. 4.

At task 431, the government entity 402 may perform a review of all bids received prior to the conclusion of the time period established for competitive bidding. The government entity 402 may submit a result of the competitive bidding to the government module 116 via the government system 104. The result may identify a winning digital bid and the corresponding winning bidder. At block 432 in the embodiment of FIG. 4, the bid of the bidder 404 is shown to be accepted by the government entity 402 and this result is conveyed to the bidder module 118 via the government module 116. For the sake of brevity, each arrow in FIG. 4 is not identified with a reference numeral or explained in any appreciable detail in view of earlier discussion of similar arrows (such as arrows 417, 420, and the like). The bidder module 118 may electronically provide the result of the competitive bidding to each bidder participating in the bidding process.

The bidder module 118 may electronically provide the government's decision to the (winning) bidder 404 in a manner similar to that discussed before with reference to arrow 420. As in case of the task 419, at task 434, the (winning) bidder 404 may retrieve the government's decision (from the bidder module 118) by logging into the third party's online platform or the bidder 404 may automatically receive the decision from the bidder module 118, for example, into a designated e-mail account of the bidder 404. Thereafter, at task 435, the bidder 404 may perform the public works project as per its contractual obligations in the government's solicitation.

It is noted here that the bidding application 114 may allow buyers (for example, the government entity 402) and sellers (such as the bidder 404) to keep track of bid solicitation opportunities and bid submissions. In one embodiments, the buyer and the seller may access all the communication that occurred during the project solicitation and performance. They may also see which digital documents were uploaded onto the platform to be filled out electronically. The bidding application 114 may allow the buyers to manage all their posted bids and the sellers to manage what solicitations they have responded to in one central online location. All uploaded contents (for example, digital solicitations, digital bids, and the like) and online communications (chats, discussions, and so on) may be stored in the database 120 (FIG. 1) as noted before.

In particular embodiments, once the procurement process is executed via contracts, agreements, or purchase orders, the supplies and services provided by contractors and suppliers may be subject to a user rating performed by the buyer entity. In the context of FIG. 4, the government entity 402 may review and rate the performance of the (winning) bidder 404 upon completion of the contractual obligations by the bidder 404 for the government's public works project, as noted at block 437. The user rating system may be a quick numeric scale (for example, on a scale of numbers “1” through “5”, with the number “5” representing the best value for a rating criterion), a sliding-scale survey, or any other suitable user rating method for evaluating the performance of the bidder 404. In some embodiments, the user rating may be based on several factors such as, for example, safety of the performance, responsiveness, communication, workmanship, community engagement, environmental impact, warranties, change orders, life cycle, and cost. The user rating may allow the government entity 402 to be alerted if a service, product, or materials used by the bidder 404 does not meet the government's bid solicitation expectations.

As indicated by arrow 438, the government module 116 may receive a feedback from the government entity 402 (containing the performance rating or user rating of the bidder 404 on the public works project). In one embodiment, the government module 116 may link the received feedback to the bidder-specific user profile of the bidder 404. Therefore, in the future, the same or another government entity may view the bidder's 404 user ratings online (on the third party's website) and, if they are not satisfactory, the concerned government entity may reject the bidder 404 even the bidder 404 is the lowest bidder and award the contract to the second lowest bidder that has better user ratings and, hence, may be more qualified to meet the solicitation request. The online user rating system may keep the contractors and suppliers accountable and may reduce poor workmanship, over-selling beyond capabilities, and selling defective products/services to government entities who are easily targeted currently based on their antiquated procurement process.

It is noted here that the tasks and their order of execution depicted in FIG. 4 are exemplary in nature, and so are the contents of the database 120. In some embodiments, tasks in addition to or different from those shown in FIG. 4 may be performed and different data may be stored in the database 120 to carry out the competitive bidding as per teachings of the present disclosure. Furthermore, it is understood that the same person may not perform all of the human-based tasks associated with the government entity 402 or the bidder 404 in FIG. 4. For example, one user from the government entity 402 may perform the task 406, another user may participate in the digital planning task 411, whereas a third user may perform the tasks 413, 415. In any event, it is irrelevant to the present disclosure who (whether the same user or different users) actually performs a specific task.

FIGS. 5A-5D illustrate exemplary screenshots that may be generated during implementation of the digital project-based competitive bidding as per particular embodiments of the present disclosure. It is understood that the contents shown in FIGS. 5A-5D may be retrieved from the database 120 by the bidding application 114 for display on the relevant webpage of the third party's website (hosted by the bid management system 102). As mentioned before, a user from the government entity or a representative of the bidder may click on a link, URL, or shortcut using browsers on their respective systems 104, 106 to access the third party's website from which they can access their user accounts as well as view different web pages like those shown in FIGS. 5A-5D. Because of the earlier detailed discussion of FIGS. 1-4, only a brief explanation of the screenshots in FIGS. 5A-5D is provided here for the sake of brevity. The screenshot 500 in FIG. 5A is an exemplary webpage showing details that may be required to be submitted by a government entity (such as the government entity 402 in FIG. 4) as part of creating the entity-specific user profile (such as the task 406 in FIG. 4). The left-most portion 502 of the screenshot 500 shows an option to invite team members to participate, for example, in planning a solicitation (such as the digital planning task 411 in FIG. 4). The central portion 503 of the screenshot 500 has various fields for entering details of the user profile, and the right-most portion 504 indicates an exemplary list of items for which the government entity 402 may provide information as part of creating its user profile.

The screenshot 506 in FIG. 5B illustrates exemplary details of a digital twin of a room that may be generated by a buyer (for example, a homeowner) when looking for competitive bids from qualified sellers (such as, for example, contractors or architects specializing in renovation projects). As noted before, the digital twin may be created from digital images of a physical object and may provide a digital replica of the physical object. The seller viewing the digital twin 506 may substantially accurately visualize the geometry and dimensions of various objects in the view and, hence, may accurately assess the scope of the project and be able to provide an accurate estimate of the cost promptly without the need to physically visit the room or read any text provided by the buyer describing the details of the project.

The screenshot 508 in FIG. 5C shows exemplary details of a part of a digital project created by a government entity for inviting bids to repair a manhole pipe. The digital project may include two images—an engineering drawing 510 of the manhole under consideration, and a digital image 511 of the actual manhole with defects identified by circles 513-515. As mentioned earlier, a robotic camera or automated laser scanner may be deployed to take images or videos underground to identify the locations and severity of defects 513-515. The digital project also may “link” the engineering drawing 510 with the defects 513-515. For example, as shown by arrow 516, the viewer may easily visualize the corresponding location of the defect 513 in the engineering drawing 510 to accurately assess the damage and repair costs. Although not shown in FIG. 5C, other defects 514-515 also may be similarly identified on the engineering drawing 510 to provide an accurate representation of the expected tasks to the potential bidders.

The illustration 520 in FIG. 5D shows a primary screenshot 522 and associated other screenshots 526, 529, 531, 533, and 535-536. The primary screenshot 522 shows a webpage that may be presented to a government user when the user logs into government entity's online user account on the third party's website. It is understood that, in some embodiments, all of the screenshots shown in FIG. 5D may not be simultaneously displayed on a single webpage. Rather, each screenshot may be displayed when a corresponding tab or option is selected in the primary screenshot 522. In particular embodiments, relevant similar screenshots may be visible to bidders as well. The webpage of the primary screenshot 522 may have two portions—an auxiliary portion 523 and a main portion 524. The auxiliary portion 523 may list current bidding opportunities and their status (awarded or still open) managed by the government entity in a specific geographical area. As mentioned earlier, a bidder may be presented with one or more of these opportunities if they satisfy the criteria specified by the bidder (for example, based on the keywords or geographical preference selected by the bidder). In one embodiment, the government user (or a bidder presented with such choices) may hover a cursor or other computer pointing device over an item on the list 523 or click anywhere on the list 523 to view the bid opportunities listed in the portion 523 as geospatial location “pins” on a map of the relevant geographical area, as depicted in the exemplary screenshot 526. The user/bidder also may select a specific “pin” on the map to view a picture of the actual project available for bidding at that location. For example, the insert image 527 in FIG. 5D shows one such picture of road construction and sewage work offered as a public works project for competitive bidding.

The main portion 524, on the other hand, may have various tabs (constituting the top bar 525 of the main portion 524) that provide details of a specific solicitation the government user is currently reviewing. As mentioned above, a similar screenshot with relevant bidder-specific details may be presented to a bidder as well. The details in the main portion 524 may include, for example: (i) the general information and buyer's requirements about the solicitation; (ii) a list of electronic documents submitted/uploaded by the government entity (as part of the digital project created for the relevant solicitation) as illustrated in the screenshot 529 when the “Documents” tab in the top bar 525 is selected by the government user; (iii) any questions received from potential bidders and answers provided by the government entity (such as, for example, during the task 422 in FIG. 4) as illustrated in the screenshot 531 when the “Questions” tab in the top bar 525 is selected by the government user; (iv) a list of bidders who have submitted bids and their bid submission status as illustrated in the screenshot 533 when the “Plan Holders” tab in the top bar 525 is selected by the government user; (v) a list of potential bidders (not shown) that are qualified to bid on the project (but all of whom may not bid and, hence, may not appear in the “Plan Holders” screenshot 533) and to whom the digital solicitation was sent (for example, by the bid management system 102 based on keyword matches), which may be visible when the “Applicants” tab is selected in the top bar 525; and (vi) a history of chat messages exchanged between the government entity and various bidders (for example, during the digital planning phase 411 and/or in the chat room at task 422 in FIG. 4) as illustrated in the screenshots 535-536 when the “Chat” tab in the top bar 525 is selected by the government user.

As noted before, the digital project based competitive bidding as per teachings of the present disclosure may be used by any buyer (for example, home owners or residents) to create a digital solicitation (or digital asset) using budget, historical data, documents, media files, phone images, video, and the like, to immediately request repairs to infrastructure, property insurance quotes, mortgages, contractor estimates for ongoing maintenance, or other services. In one embodiment, the bidding application 114 may combine the information provided by the bidders of government solicitations with the information received from government entities to generate data that may be used to predict future and current public works or other infrastructure needs of the communities. This information can be used to plan for logistics and staffing needed by private sector contractors and suppliers to meet government's need for goods and services.

FIG. 6 depicts an exemplary arrangement 600 to implement the digital project-based competitive bidding in a secure, de-centralized network as per particular embodiments of the present disclosure. As indicated at block 602, the de-centralized network may be a blockchain based network in which digital solicitations and digital bids generated as per the teachings of the present disclosure may be stored as smart contracts to maintain the security and integrity of their contents. In the arrangement 600, the smart contracts 602 are shown connected to the bid management system 102 via an oracle network interface 604. The BMS system 102, in turn, is shown connected to the government system 104 and the bidder system 106 in a manner similar to that in the embodiment of FIG. 1 (and, hence, not further discussed here). In one embodiment, the smart contracts may be implemented using the Ethereum technology discussed in more detail at https://ethereum.org. A smart contract may be a computer program or a transaction protocol which is intended to automatically execute, control or document legally relevant events and actions according to the terms of a contract or an agreement. The smart contracts may reduce the need for trusted intermediaries, arbitrations and enforcement costs, and fraud losses, as well as reduce malicious and accidental exceptions. Smart contracts may be written into code on a blockchain. A network of computers executes the actions when predetermined conditions have been met and verified. These actions could include releasing funds to the appropriate parties, registering a vehicle, sending notifications, or issuing a ticket. The blockchain is then updated when the transaction is completed. That means the transaction cannot be changed, and only parties who have been granted permission can see the results.

It is noted here that external resources (for example, a data provider supplying digital twin content for a project, the government entity reviewing the performance of the winning bidder, a payment service processing the payment to a bidder, and so on) may affect various facets of the competitive bidding such as, for example, the generation and execution of digital solicitations, evaluations of digital bids, and review of the winning bidder's performance. However, due to the consensus mechanism of blockchains, smart contracts have no built-in capabilities for interacting with external resources. Because interactions with external resources affecting the creation and execution of a digital solicitation may be needed to verify the outcome of real-world events happening outside the blockchain, the oracle network interface 604 may be used as a middleware (between the BMS system 102 and the smart contracts 602) to retrieve external data inputs and push data outputs to external systems. The oracle network interface 604 may serve as a two-way bridge between smart contracts 602 and the outside world (here, the BMS system 102), and also may provide a security framework for protecting against any single point of failure such as data manipulation and downtime. In one embodiment, the oracle network 604 may be de-centralized or heterogeneous. In another embodiment, the oracle network 604 may be monolithic. In some embodiments, the oracle network interface 604 may be based on a Chainlink® framework discussed in more detail at https://blog.chain.link.

As illustrated by dotted arrow 606 in FIG. 6, the BMS system 102 (upon execution of the bidding application 114) may use the network interface 604 to save the digital solicitation— including digital project(s) and bid document(s)— and other content (such as, for example, review of bids, project completion status, performance review of the winning bidder, and so on) received from the government system 104 as a smart contract 602. Although not shown in FIG. 6 by a similar arrow, content received from the bidder system 106 (such as, for example, a winning digital bid) also may be stored as part of the relevant smart contract 602 using the network interface 604. In particular embodiments, the BMS system 102 (upon execution of the bidding application 114) may use the network interface 604 to facilitate payment from the government entity (or other buyer) to the winning bidder in a blockchain environment, as indicated by the dotted arrow 608. The payment may be in any one of the following forms or in a combination of two or more of the following forms: as a traditional currency (for example, US dollars, or other national currency), as a non-traditional monetary instrument (for example, fungible tokens like stablecoins), as a digital currency (for example, an Electronic Fund Transfer (EFT) payment, or a payment through an e-commerce payment processor like PayPal® or Zelle®), as a cryptocurrency (for example, Bitcoins or Ethers), and/or a non-fungible token (NFT).

The foregoing discussion of FIGS. 1-6 illustrates how a substantially fully-digital procurement process may be implemented for government contracts to expeditiously fulfill a government entity's procurement needs within a geographical location in a fair and competitive manner. Online digital projects created using audio and video technologies allow potential bidders to easily visualize the tasks and competitively bid for them. Audio and visual features may be added to all stages—communication among stakeholders, planning of a digital project, preparation of a digital solicitation, and bidding on the solicitation—of the competitive bidding process. Substantially all project specification documents may be replaced using visual and audio technologies, and blockchain-based smart contracts to enable the government entity to digitally execute a procurement solicitation. Potential suppliers and contractors may be connected on a geospatial location mapping system to expedite the procurement and add accessibility to local businesses, connect minority businesses, and create local economic sustainability. User rating may make the bidding process more transparent, fair, and competitive.

As mentioned before, although the discussion of FIGS. 1-6 primarily focuses on competitive bidding in government contracts, the teachings of the present disclosure remain equally applicable to competitive bidding in many other areas—whether in a business-to-business (B2B) setting (such as, for example, a motel owner seeking competitive bids for motel renovation), or a non-B2B setting (such as, for example, a homeowner looking to invite competitive bids from contractors for a home repair project), and also whether the bid is solicited for a construction project or a non-construction project (e.g., a vacation home rental, to operate a daycare center, and the like). However, for ease of description and for the sake of brevity, all potential use cases of the present disclosure are not discussed here.

FIG. 7 illustrates an example configuration of a computer system, such as the bid management system 102 of FIG. 1, that can be used to implement the competitive bidding methodology described herein. As discussed before, the computer system (also interchangeably referred to as “computing system” or “computing device”) 102 may be suitably configured to implement the functionality of the bidding application 114 according to the teachings of the present disclosure. The computer system 102 may include one or more processors 700, a memory unit 702, an interface unit 704 providing communication interfaces, one or more input devices 706, one or more output devices 708, and a peripheral storage unit 710, connected to the processor 700 as shown and configured to communicate with each other, such as via one or more system buses (not shown) or other suitable connection.

In one embodiment, the input devices 706 may provide user/operator inputs—such as, for example, a confirmation that a qualifying bid has been received from a supplier, a chatroom has been established by the buyer, a user profile has been successfully created by a user, and the like, as discussed before with reference to FIGS. 4-5—to the processor 700 and the bidding application 114 for further processing. The input devices 706 may include, for example, a touchpad, a camera, a computer keyboard, a touch-screen, a joystick, a physical or virtual “clickable button,” a computer mouse/pointing device, and the like. A display screen is an example of the output device 708. Other examples of an output device include a graphics/display device, a computer screen or monitor, an alarm system, or any other type of data output device. In some embodiments, the input device(s) 706 and the output device(s) 708 may be coupled to the processor 700 via an I/O or peripheral interface(s). In some embodiments, the computer system 102 may include more than one instance of the devices shown. In various embodiments, all of the components shown in FIG. 7 may be housed within a single housing. In other embodiments, the computer system 102 may not include all of the components shown in FIG. 7. Furthermore, the computing system 102 may be configured as a standalone system, as a server system, as a client system (of another server), as a cluster of networked computers, as a virtual machine (e.g., within a cloud computing system), or in any other suitable form factor.

The processor 700 is a hardware device that may include a single processing unit or a number of processing units, all of which may include single or multiple computing units or multiple cores. When the computing device 102 is a multiprocessor system, there may be more than one instance of the processor 700 or there may be multiple other processors coupled to the processor 700 via their respective interfaces (not shown). The processor 700 may include an integrated Graphics Processing Unit (GPU) or the GPU may be a separate processor device in the system 202. The processor 700 may be implemented as one or more microprocessors, microcomputers, microcontrollers, Digital Signal Processors (DSPs), Central Processing Units (CPUs), Graphics Processing Units (GPUs), state machines, logic circuitries, virtual machines, and/or any devices that manipulate signals based on operational instructions. Among other capabilities, the processor 700 may be configured to fetch and execute computer-readable instructions stored in the memory 702, the peripheral storage 710, or other computer-readable media. In some embodiments, the processor 700 may be a System on Chip (SoC).

The memory 702 and the peripheral storage unit 710 are examples of non-transitory computer media (e.g., memory storage devices) for storing instructions that can be executed by the processor 700 to perform the various functions described herein. In some embodiments, the memory 702 and the peripheral storage unit 710 may include tangible, computer-readable data storage media. For example, the memory unit 702 may include both volatile memory and non-volatile memory (e.g., RAM, ROM, or the like) devices. Further, in particular embodiments, the peripheral storage unit 710 may include one or more mass storage devices such as, for example, hard disk drives, solid-state drives, removable media, including external and removable drives, memory cards, flash memory, floppy disks, optical disks (e.g., CD, DVD), a storage array, a network attached storage, a storage area network, or the like. Both memory 702 and mass storage devices constituting the peripheral storage 710 may be collectively referred to as “memory” or “computer storage media” herein, and may be a media capable of storing computer-readable, processor-executable program instructions as computer program code that can be executed by the processor 700 as a particular machine (or special purpose machine) configured for carrying out the operations and functions described in the implementations herein. In some embodiments, the database 120 (FIG. 1) may be a part of such computer storage media. In other embodiments, such computer storage media may be an online cloud-based storage.

The computing device 102 may also include one or more communication interfaces as part of its interface unit 704 for exchanging data via a network (such as the communication network 108 in FIG. 1). The communication interfaces can facilitate communications within a wide variety of networks and protocol types, including wired networks (e.g., Ethernet, Digital Subscriber Loop (DSL), Data Over Cable Service Interface Specification (DOCSIS), Fiber Optics network, Universal Serial Bus (USB), etc.) and wireless networks (e.g., Wireless Local Area Network (WLAN), Global System for Mobile Communications (GSM), Code Division Multiple Access (CDMA), Institute of Electrical and Electronics Engineers (IEEE) standard 802.11, Bluetooth®, Wireless USB, cellular, satellite, etc.), the Internet (or, more generally, the IP network 208), and the like. Communication interfaces in the interface unit 704 can also provide communication with an external storage (not shown in FIG. 7), such as in a storage array, network attached storage, storage area network, one or more databases, or the like. For example, if the database 120 in FIG. 1 is implemented as an external storage, the interface unit 704 may facilitate communication with that database.

The computer storage media, such as the memory 702 and the mass storage devices in the peripheral storage 710, may be used to store software and data. For example, the computer storage media may be used to store the operating system (OS) for the computing device 102, various device drivers for the device 102, various inputs provided by the user/operator of the device 102 during the implementation of the competitive bidding methodology discussed before with reference to FIGS. 1-6 or received from the government system 104 (for example, digital solicitation information) and the bidder system 106 (for example, a digital bid) at run-time, and the data such as audio content, video content, text data, streaming content, or any other type of content. The computer storage media also may store software applications such as a word processing application, a spreadsheet application, the bidding application 114 (including the software modules 116, 118), and the like. The program code for the software applications and the OS may be executed by the processor 700.

In one embodiment, a non-transitory, computer-readable data storage medium, such as, for example, the system memory 702 or the peripheral data storage unit 710 may store program code or software for the bidding application 114 as per particular embodiments of the present disclosure. In the embodiment of FIG. 7, the system memory 702 is shown to include such program code. Such computer-readable data storage medium may be considered an article of manufacture. In the embodiment of FIG. 7, the bidding application 114 may operate in conjunction with the OS (not shown) of the computing system 102. The processor 700 may be configured to execute the program code for the bidding application 114, whereby the computer system (or computing device) 102 may be operative to perform various (online) competitive bidding related tasks as per the teachings of the present disclosure. In particular embodiments, such tasks may include, for example, the process steps illustrated in FIG. 2 as well as other relevant tasks discussed with reference to FIGS. 1 and 4-6 such as, for example, reception of user profile data from the respective systems 104, 106, facilitation of digital planning, assistance in generation of a digital project, reception and storage of contents of a digital solicitation in the database 120 for retrieval by a potential bidder, reception of digital bids from bidders and transmission of received bids to the government entity (for example, to the government system 104), provision of an online communication platform (such as, for example, an Internet-based website) to “link” a buyer (government entity) and a seller/bidder, and so on. The program code or software for the bidding application 114 may be proprietary software or open source software which, upon execution by the processor 700, may enable the computer system 102 to perform operations related to the digital competitive bidding as per teachings of the present disclosure. As a result, the computer system 102 may operate as a special purpose system/device.

In particular embodiments, the computing device 102 may include an on-board power supply unit 712 to provide electrical power to various system components illustrated in FIG. 7. The power supply unit 712 may receive batteries and/or may be connectable to an AC electrical power outlet. In one embodiment, the power supply unit 712 may convert solar energy or other renewable energy into electrical power.

The example systems and computing devices described herein are merely examples suitable for some implementations and are not intended to suggest any limitation as to the scope of use or functionality of the environments, architectures and frameworks that can implement the processes, components and features described herein. Thus, implementations herein are operational with numerous environments or architectures, and may be implemented in general purpose and special-purpose computing systems, or other devices having processing capability, and, hence, are considered machine-implemented. Generally, any of the functions described with reference to the figures can be implemented using software, hardware (e.g., fixed logic circuitry) or a combination of these implementations. The terms “module,” “mechanism” or “component” as used herein generally represents software, hardware, or a combination of software and hardware that can be configured to implement prescribed functions. For instance, in the case of a software implementation, the term “module,” “mechanism” or “component” can represent program code (and/or declarative-type instructions), such as the program code for the bidding application 114 (including the software modules 116, 118), that performs specified tasks or operations when executed on a processing device or devices (e.g., CPUs or processors). The program code can be stored in one or more computer-readable memory devices or other computer storage devices. Thus, the processes, components and modules described herein may be implemented by a computer program product.

Although the present disclosure has been described in connection with several embodiments, the disclosure is not intended to be limited to the specific forms set forth herein. On the contrary, it is intended to cover such alternatives, modifications, and equivalents as can be reasonably included within the scope of the disclosure as defined by the appended claims.

What is claimed is:

1. A method comprising:
receiving, by a computing system, a digital solicitation from a government entity for a public works project being offered by the government entity for competitive bidding, wherein the digital solicitation includes:
an electronic contract document containing procurement terms and conditions of the government entity for the public works project, and
a digital project comprising data that enable electronic visualization of a geographical location, physical attributes, and critical ancillary details of the public works project to facilitate an expeditious bidding without a need for a visit to a physical location of the public works project and a review of textual details of the public works project;
electronically providing, by the computing system, the digital solicitation to a plurality of bidders;
hosting, by the computing system, an online question-and-answer session of a pre-defined duration between the government entity and the plurality of bidders to enable one or more bidders in the plurality of bidders to discuss the digital solicitation with the government entity prior to conclusion of time period for competitive bidding;
receiving, by the computing system, a bidder-specific digital bid for the digital solicitation from one or more bidders in the plurality of bidders;
electronically providing, by the computing system, all received digital bids to the government entity for review;
receiving, by the computing system, a result of the competitive bidding from the government entity identifying a winning digital bid and a corresponding winning bidder from the plurality of bidders; and
electronically providing, by the computing system, the result of the competitive bidding to each bidder in the plurality of bidders.

2. The method of claim 1, wherein the pre-defined duration for the online question-and-answer session is established by the government entity and terminates prior to the conclusion of the time period for competitive bidding.

3. The method of claim 1, wherein the digital project comprises two or more of the following:
an annotated digital image of the public works project;
a digital twin generated from pictures associated with the public works project;
a three-dimensional (3D) digital model of the public works project;
a digital video related to the public works project;
a digital audio recording related to the public works project;
a Geographical Information System (GIS) location data for the public works project;
a drone footage of the public works project;
a geospatial location information for the public works project;
a link to a digital media file containing data about the public works project;
a plurality of standardized construction codes relevant to the public works project and embedded with visual aids identifying the public works project; and
electronic documents providing constructional details of the public works project.

4. The method of claim 1, further comprising:
providing, by the computing system, online tools to the government entity to assist the government entity in creating at least a portion of the digital project.

5. The method of claim 1, further comprising:
providing, by the computing system, an online platform to facilitate communication between the government entity and the plurality of bidders, and also between the government entity and a professional affiliate of the government entity to accomplish at least one of the following:
enable the professional affiliate to assist the government entity in planning the public works project,
enable the professional affiliate to assist the government entity in creating the digital solicitation,
enable one or more bidders in the plurality of bidders to assist the government entity in planning the public works project, and
enable one or more bidders in the plurality of bidders to assist the government entity in creating the digital solicitation.

6. The method of claim 1, further comprising:
allowing, by the computing system, each bidder in the plurality of bidders to create a bidder-specific user profile on the computing system, wherein the bidder-specific user profile includes:
a first plurality of keywords selected by a respective bidder indicting a bid preference of the respective bidder,
a physical address of the respective bidder, and
an indication of geographical service area of the respective bidder.

7. The method of claim 6, wherein electronically providing the digital solicitation includes:
analyzing, by the computing system, the digital solicitation to determine a second plurality of keywords contained therein;
for each bidder in the plurality of bidders, comparing, by the computing system, the first plurality of keywords in the bidder-specific user profile to the second plurality of keywords; and
electronically providing, by the computing system, the digital solicitation to each bidder in the plurality of bidders that has the first plurality of keywords in the bidder-specific user profile matching the second plurality of keywords beyond a pre-defined threshold.

8. The method of claim 6, wherein receiving the digital solicitation includes:
receiving, by the computing system, a geographical preference for the public works project from the government entity;
and wherein electronically providing the digital solicitation includes:
sending, by the computing system, the digital solicitation to each bidder in the plurality of bidders whose indication of geographical service area in the bidder-specific user profile satisfies the geographical preference received from the government entity.

9. The method of claim 6, further comprising:
receiving, by the computing system, a feedback from the government entity rating a performance of the winning bidder on the public works project; and
linking, by the computing system, the feedback to the bidder-specific user profile of the winning bidder.

10. The method of claim 1, further comprising at least one of the following:
storing, by the computing system, at least a portion of the digital solicitation as a blockchain-based first smart contract; and
storing, by the computing system, at least the winning digital bid from all the digital bids received by the government entity as a blockchain-based second smart contract.

11. The method of claim 1, further comprising:
facilitating, by the computing system, a payment from the government entity to the winning bidder in at least one of the following forms:
a traditional currency;
a non-traditional monetary instrument;
a digital currency;
a cryptocurrency; and
a non-fungible token (NFT).

12. A computer program product comprising a non-transitory computer-usable medium having computer-readable program code embodied therein, wherein the computer-readable program code, when executed by a computing system, causes the computing system to implement a method comprising:
receiving a digital solicitation from a government entity for a public works project being offered by the government entity for competitive bidding, wherein the digital solicitation includes:
an electronic contract document containing procurement terms and conditions of the government entity for the public works project, and
a digital project comprising data that enable electronic visualization of a geographical location, physical attributes, and critical ancillary details of the public works project to facilitate an expeditious bidding without a need for a visit to a physical location of the public works project and a review of textual details of the public works project;
electronically providing the digital solicitation to a plurality of bidders;
hosting an online question-and-answer session of a pre-defined duration between the government entity and the plurality of bidders to enable one or more bidders in the plurality of bidders to discuss the digital solicitation with the government entity prior to conclusion of time period for competitive bidding, wherein the pre-defined duration for the online question-and-answer session is established by the government entity and terminates prior to the conclusion of the time period for competitive bidding;
receiving a bidder-specific digital bid for the digital solicitation from one or more bidders in the plurality of bidders;
electronically providing all received digital bids to the government entity for review;
receiving a result of the competitive bidding from the government entity identifying a winning digital bid and a corresponding winning bidder from the plurality of bidders; and
electronically providing the result of the competitive bidding to each bidder in the plurality of bidders.

13. The computer program product of claim 12, wherein the method further comprises:
providing online tools to the government entity to assist the government entity in creating at least a portion of the digital project; and
further providing an online platform to facilitate communication between the government entity and the plurality of bidders, and also between the government entity and a professional affiliate of the government entity to accomplish at least one of the following:
enable the professional affiliate to assist the government entity in planning the public works project,
enable the professional affiliate to assist the government entity in creating the digital solicitation,
enable one or more bidders in the plurality of bidders to assist the government entity in planning the public works project, and
enable one or more bidders in the plurality of bidders to assist the government entity in creating the digital solicitation.

14. The computer program product of claim 12, wherein the method further comprises:
allowing each bidder in the plurality of bidders to create a bidder-specific user profile that includes a first plurality of keywords selected by a respective bidder indicting a bid preference of the respective bidder, and an indication of geographical service area of the respective bidder; and
electronically providing, by the computing system, the digital solicitation to each bidder in the plurality of bidders that has the first plurality of keywords in the bidder-specific user profile matching a second plurality of keywords in the digital solicitation beyond a pre-defined threshold and whose indication of geographical service area in the bidder-specific user profile satisfies a geographical preference received from the government entity.

15. The computer program product of claim 12, wherein the method further comprises at least one of the following:
storing at least a portion of the digital solicitation as a blockchain-based first smart contract;
storing at least the winning digital bid from all the digital bids received by the government entity as a blockchain-based second smart contract; and
facilitating a payment from the government entity to the winning bidder based on a blockchain-based transaction.

16. The computer program product of claim 12, wherein the method further comprises:
providing available performance history of each bidder in the plurality of bidders to the government entity to enable the government entity to evaluate the bidder-specific digital bid.

17. A computing system comprising:
a memory storing program instructions; and
a processing unit coupled to the memory and operable to execute the program instructions, which, when executed by the processing unit, cause the computing system to:
receive a digital solicitation from a government entity for a public works project being offered by the government entity for competitive bidding, wherein the digital solicitation includes:
an electronic contract document containing procurement terms and conditions of the government entity for the public works project, and
a digital project comprising data that enable electronic visualization of a geographical location, physical attributes, and critical ancillary details of the public works project to facilitate an expeditious bidding without a need for a visit to a physical location of the public works project and a review of textual details of the public works project;
provide the digital solicitation to a plurality of bidders;
host an online question-and-answer session of a pre-defined duration between the government entity and the plurality of bidders to enable one or more bidders in the plurality of bidders to discuss the digital solicitation with the government entity prior to conclusion of time period for competitive bidding;
receive a bidder-specific digital bid for the digital solicitation from one or more bidders in the plurality of bidders;
provide all received digital bids to the government entity for review;
receive a result of the competitive bidding from the government entity identifying a winning digital bid and a corresponding winning bidder from the plurality of bidders; and
provide the result of the competitive bidding to each bidder in the plurality of bidders.

18. The computing system of claim 17, wherein the digital project comprises two or more of the following:
an annotated digital image of the public works project;
a digital twin generated from pictures associated with the public works project;
a three-dimensional (3D) digital model of the public works project;
a digital video related to the public works project;
a digital audio recording related to the public works project;
a Geographical Information System (GIS) location data for the public works project;
a drone footage of the public works project;
a geospatial location information for the public works project;
a link to a digital media file containing data about the public works project;
a plurality of standardized construction codes relevant to the public works project and embedded with visual aids identifying the public works project; and
electronic documents providing constructional details of the public works project.

19. The computing system of claim 17, wherein the program instructions, upon execution by the processing unit, cause the computing system to:
provide online tools to the government entity to assist the government entity in creating at least a portion of the digital project; and
further provide an online platform to facilitate communication between the government entity and the plurality of bidders, and also between the government entity and a professional affiliate of the government entity to accomplish at least one of the following:
enable the professional affiliate to assist the government entity in planning the public works project,
enable the professional affiliate to assist the government entity in creating the digital solicitation,
enable one or more bidders in the plurality of bidders to assist the government entity in planning the public works project, and
enable one or more bidders in the plurality of bidders to assist the government entity in creating the digital solicitation.

20. The computing system of claim 17, wherein the program instructions, upon execution by the processing unit, cause the computing system to perform one of the following:
store at least a portion of the digital solicitation as a blockchain-based first smart contract;
store at least the winning digital bid from all the digital bids received by the government entity as a blockchain-based second smart contract; and
facilitate a payment from the government entity to the winning bidder based on a blockchain-based transaction.
